(19) United States
(12) Patent Application Publication
(10) Pub. No.: US 2026/0202773 A1
(43) Pub. Date: Jul. 16, 2026

(54) ELECTROPHOTOGRAPHIC PHOTOSENSITIVE MEMBER, PROCESS CARTRIDGE, AND IMAGE FORMING APPARATUS

(71) Applicant: KYOCERA DOCUMENT SOLUTIONS INC., OSAKA (JP)

(72) Inventors: KATSUNORI TERAOKA, OSAKA-SHI, OSAKA (JP); TERUYUKI UEMURA, OSAKA-SHI, OSAKA (JP); TOMOFUMI SHIMIZU, OSAKA-SHI, OSAKA (JP); YOSHITAKA IMANAKA, OSAKA-SHI, OSAKA (JP)

(21) Appl. No.: 19/449,351

(22) Filed: Jan. 14, 2026

(30) Foreign Application Priority Data
Jan. 16, 2025 (JP) 2025-006024

(51) Int. Cl. G03G 5/147; G03G 5/05; G03G 5/06; G03G 21/18

(52) U.S. Cl. CPC G03G 5/14791; G03G 5/0525; G03G 5/0618; G03G 5/14786; G03G 21/1828

(57) ABSTRACT

There are provided an image forming apparatus that exhibit the excellent wear resistance and are capable of suppressing the image bleeding. The electrophotographic photosensitive member includes a conductive base, a photosensitive layer, and a protective layer. The photosensitive layer is provided on the conductive base. The protective layer is provided on the photosensitive layer. The protective layer has a base material formed from a graft polymer configured of a UV (ultraviolet) curable multifunctional monomer, a photopolymerization initiator, and a photoreactive group-containing substance; n-type conductive microparticles dispersed in the base material; and metal oxide microparticles dispersed in the base material, and has a Martens hardness of 400 N/mm² or more and a volume resistivity of 1.0×10¹⁰ Ω·cm or more.

### CROSS-REFERENCE TO RELATED PATENT APPLICATION

This application claims the benefit of Japanese Priority Patent Application JP 2025-006024 filed on Jan. 16, 2025, the entire contents of which are incorporated herein by reference.

### FIELD OF THE DISCLOSURE

The present disclosure relates to an electrophotographic photosensitive member, a process cartridge, and an image forming apparatus used in electrophotographic printing.

### BACKGROUND OF THE DISCLOSURE

An electrophotographic photosensitive member is used as an image carrier in an image forming apparatus used in electrophotographic printing such as a printer. The electrophotographic photosensitive member includes a photosensitive layer laminated on a conductive base, and the photosensitive layer has a structure having a thermoplastic binder resin into which functional materials are dispersed. Repeated use of the electrophotographic photosensitive member causes wear of the photosensitive layer, and its service life ends when the photosensitive layer reaches a limit thickness. In response to this, the electrophotographic photosensitive member has been reported that achieve significantly improved wear resistance and extended service life by forming a protective layer on the photosensitive layer using a thermocurable resin or a photocurable resin.

### SUMMARY OF THE DISCLOSURE

To achieve the above object, an electrophotographic photosensitive member according to an embodiment of the present disclosure includes a conductive base, a photosensitive layer, and a protective layer.

The photosensitive layer is provided on the conductive base.

The protective layer is provided on the photosensitive layer.

The protective layer has a base material formed from a graft polymer configured of a UV (ultraviolet) curable multifunctional monomer, a photopolymerization initiator, and a photoreactive group-containing substance, n-type conductive microparticles dispersed in the base material, and metal oxide microparticles dispersed in the base material, and has a Martens hardness of 400 N/mm² or more and a volume resistivity of 1.0×10¹⁰ Ω·cm or more.

The UV curable multifunctional monomer may have three or more (meth)acrylic groups.

The photoreactive group-containing substance may be a graft polymer having an organic main chain and a side chain having multiple reactive groups and a fluorine-modified silicone skeleton or silane skeleton as a release skeleton.

The photopolymerization initiator may be an acylphosphine oxide.

The protective layer may have a thickness of 2 μm or more and 3 μm or less.

The photosensitive layer may contain an electron transport material including any compound represented by the following general formulae (1) to (6).

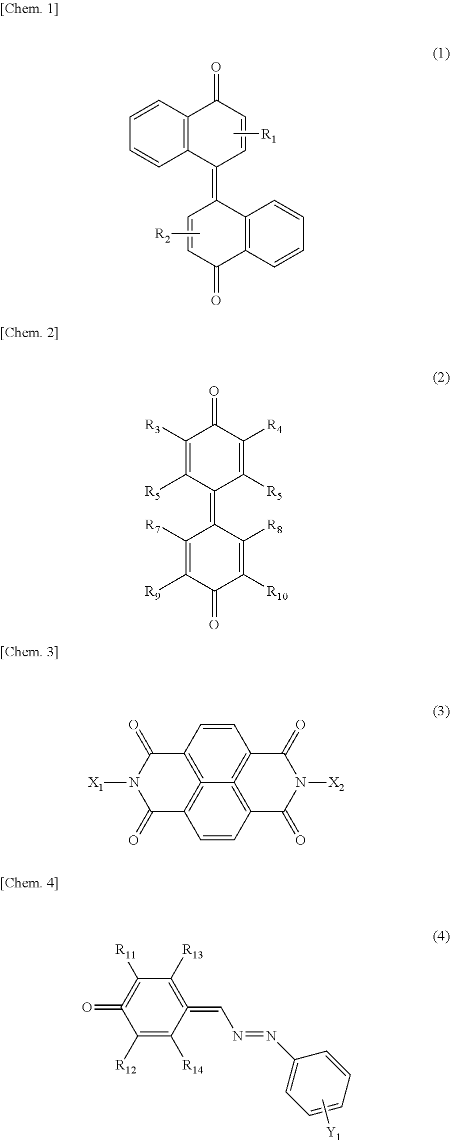

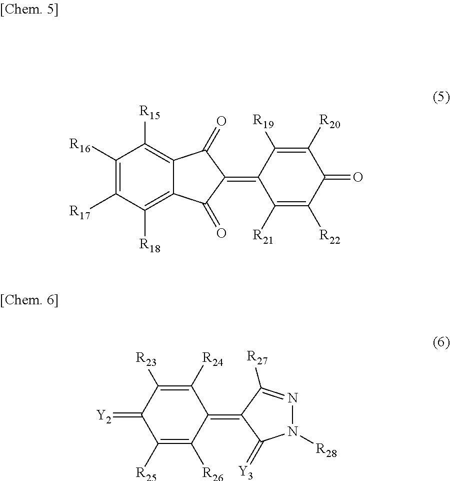

In general formulae (1) to (6), R₁ to R₂₈ each independently represents a hydrogen atom, a halogen atom, a cyano group, or an alkyl group having 1 to 6 carbon atoms; X₁ and X₂ each independently represents an alkenyl group having 2 to 6 carbon atoms, an alkoxy group having 1 to 6 carbon atoms, or an aryl group having 6 to 14 carbon atoms which may have at least one alkyl group having 1 to 6 carbon atoms; Y₁ to Y₃ each independently represents a halogen group or an oxygen atom.

The photosensitive layer may contain a hole transport material including any compound represented by the following general formulae (7) to (10).

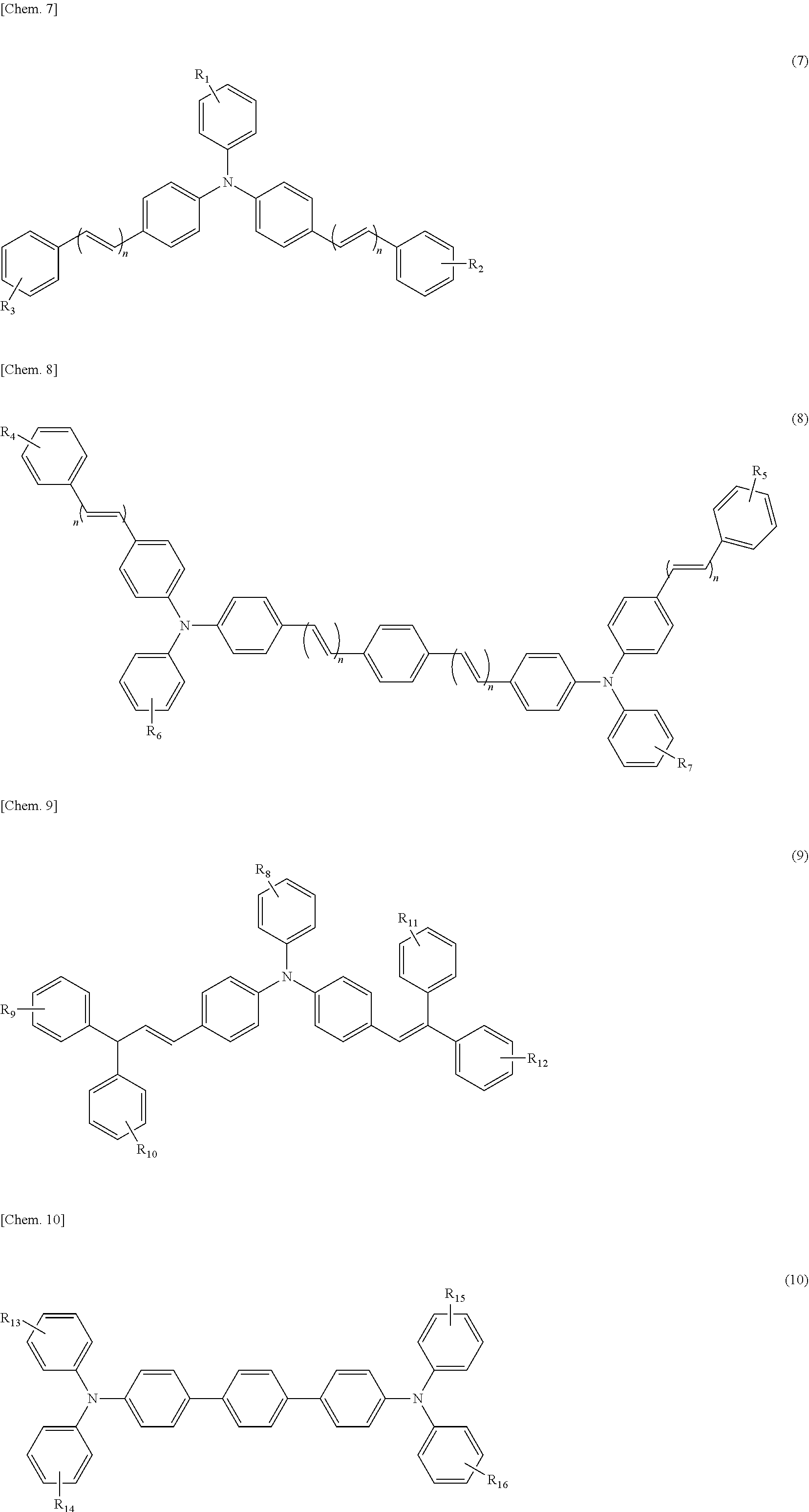

In general formulae (7) to (10), R₁ to R₁₆ each independently represents a hydrogen atom, an alkyl group having 1 to 8 carbon atoms, or a phenyl group; n represents a natural number of 1 or less.

The photosensitive layer may contain a charge generation material which is a titanyl phthalocyanine or an inorganic phthalocyanine.

The protective layer may be formed by coating a coating solution including the UV curable multifunctional monomer, the photoreactive group-containing substance, the photopolymerization initiator, the n-type conductive microparticles, and the metal oxide microparticles onto the photosensitive layer, and then irradiating the coating solution with light.

The light may be light having a wavelength of 365 nm.

In order to achieve the above object, a process cartridge according to an embodiment of the present disclosure includes a conductive base, a photosensitive layer, and a protective layer.

The photosensitive layer is provided on the conductive base.

The protective layer is provided on the photosensitive layer.

The protective layer includes a base material formed from a graft polymer configured of a UV curable multifunctional monomer, a photopolymerization initiator, and a photoreactive group-containing substance; n-type conductive microparticles dispersed in the base material; and metal oxide microparticles dispersed in the base material, and has a Martens hardness of 400 N/mm² or more and a volume resistivity of 1.0×10¹⁰ Ω·cm or more.

In order to achieve the above object, an image forming apparatus according to an embodiment of the present disclosure includes an electrophotographic photosensitive member, a charging device, an exposure device, a developing device, and a transfer device.

The electrophotographic photosensitive member includes a conductive base, a photosensitive layer provided on the conductive base, and a protective layer provided on the photosensitive layer.

The charging device charges a surface of the electrophotographic photosensitive member.

The exposure device exposes the charged surface to form an electrostatic latent image on the surface.

The developing device develops the electrostatic latent image into a toner image.

The transfer device transfers the toner image from the electrophotographic photosensitive member to a transfer target.

The protective layer includes a base material formed from a graft polymer configured of a UV curable multifunctional monomer, a photopolymerization initiator, and a photoreactive group-containing substance; n-type conductive microparticles dispersed in the base material; and metal oxide microparticles dispersed in the base material, having a Martens hardness of 400 N/mm² or more and a volume resistivity of 1.0×10¹⁰ Ω·cm or more.

The charging device may include a charging roller.

The developing device may be a two-component developing system, a one-component developing system, or a rub roller system.

These and other objects, features and advantages of the present disclosure will become more apparent in light of the following detailed description of best mode embodiments thereof, as illustrated in the accompanying drawings.

### BRIEF DESCRIPTION OF THE DRAWINGS

FIG. 1 is a schematic diagram of a single-layered electrophotographic photosensitive member according to an embodiment of the present disclosure.

FIG. 2 is a schematic diagram of the single-layered electrophotographic photosensitive member (including undercoat layer) according to the embodiment of the present disclosure.

FIG. 3 is a schematic diagram of a multi-layered electrophotographic photosensitive member according to an embodiment of the present disclosure.

FIG. 4 is a schematic diagram of the multi-layered electrophotographic photosensitive member (including undercoat layer) according to the embodiment of the present disclosure.

FIG. 5 is a schematic diagram showing a configuration of an image forming apparatus according to an embodiment of the present disclosure.

FIG. 6 is a schematic diagram showing a configuration of an image forming unit provided in the image forming apparatus.

### DETAILED DESCRIPTION OF THE EXEMPLARY EMBODIMENTS

Embodiments of the present disclosure will be described. An electrophotographic photosensitive member according to an embodiment of the present disclosure may be a single-layered electrophotographic photosensitive member having a single photosensitive layer, or may be a multi-layered electrophotographic photosensitive member having multiple photosensitive layers.

### <Configuration of Single-Layered Electrophotographic Photosensitive Member>

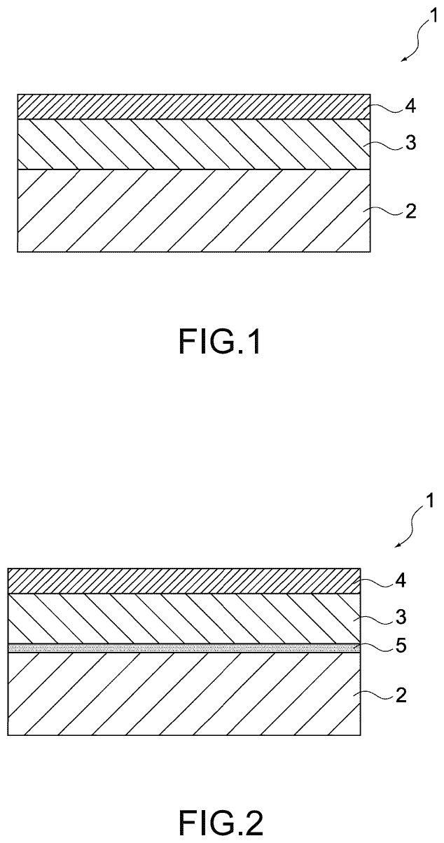

FIG. 1 is a schematic diagram of an electrophotographic photosensitive member 1 according to an embodiment of the present disclosure. As shown in FIG. 1, the electrophotographic photosensitive member 1 includes a conductive base 2, a photosensitive layer 3, and a protective layer 4. The photosensitive layer 3 is provided on the conductive base 2, and the protective layer 4 is provided on the photosensitive layer 3. The electrophotographic photosensitive member 1 is a single-layered electrophotographic photosensitive member having a single photosensitive layer 3.

The electrophotographic photosensitive member 1 may further include an undercoat layer. FIG. 2 is a schematic diagram of the electrophotographic photosensitive member 1 including an undercoat layer 5. As shown in FIG. 2, the undercoat layer 5 is provided between the conductive base 2 and the photosensitive layer 3.

A thickness of each layer is not particularly limited, but a thickness of the photosensitive layer 3 is preferably 5 μm or more and 100 μm or less, and a thickness of the protective layer 4 is preferably 2 μm or more and 3 μm or less. A thickness of the undercoat layer 5 is preferably 0.1 μm or more and 5 μm or less.

### [Configuration of Photosensitive Layer]

The photosensitive layer 3 transports negative charges generated by light absorption to a surface of the electrophotographic photosensitive member 1 (hereinafter referred to as photosensitive member surface). The photosensitive layer 3 contains a charge generation material, a hole transport material, an electron transport material, and a binder resin.

### (Charge Generation Material)

Examples of the charge generation material include a phthalocyanine pigment, a perylene-based pigment, a bisazo pigment, a trisazo pigment, a dithioketopyrrolopyrrole pigment, a non-metallic naazo compound, a metal naazo compound, a squareline pigment, an indigo pigment, an azulenium pigment, a cyanine pigment, powder of an inorganic photoconductive material (e.g., selenium, selenium-tellurium, selenium-arsenic, cadmium sulfide, and amorphous silicon), a pyridinium pigment, an anthacron-based pigment, a triphenylmethane-based pigment, a sulfen-based pigment, a toluidine-based pigment, a pyrazoline-based pigment, and a quinacridone-based pigment. The photosensitive layer 3 may contain only one type of the charge generation material or may contain two or more types of charge generation materials.

The phthalocyanine pigment is a pigment having a phthalocyanine structure. As the phthalocyanine pigment, titanyl phthalocyanine shown in the following formula (CG-1) and phthalocyanine shown in formula (CG-2) are preferred.

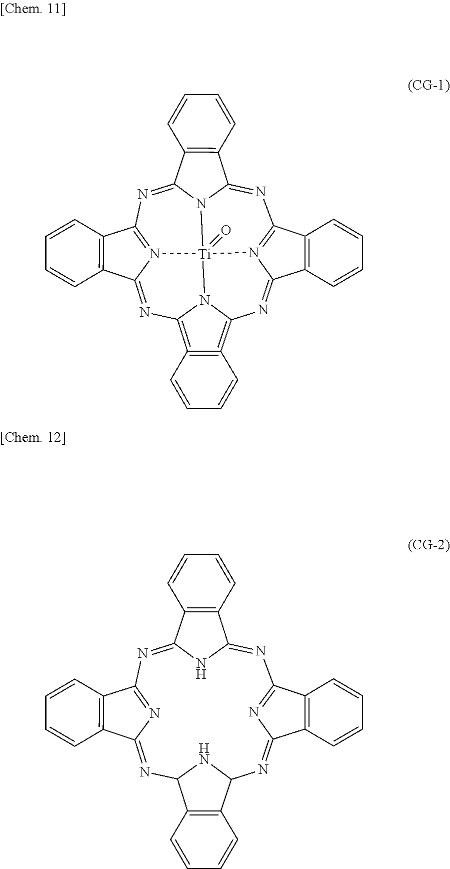

A content of the charge generation material is preferably 0.1 mass parts or more and 50 mass parts or less, and more preferably 0.5 mass parts or more and 5 mass parts or less with respect to 100 mass parts of binder resin.

### (Hole Transport Material)

Examples of the hole transport material include a triphenylamine derivative, a diamine derivative (e.g., N,N,N′,N′-tetraphenylbenzidine derivative, N,N,N′,N′-tetraphenylphenylene diamine derivative, N,N,N′,N′-tetraphenylnaphthylenediamine derivative, N,N,N′,N′-tetraphenylphenanthrenediamine derivative, and di(aminophenylvinyl)benzene derivative), an oxadiazole-based compound (e.g., 2,5-di(4-methylaminophenyl)-1,3,4-oxadiazole), a styryl-based compound (e.g., 9-(4-diethylaminostyryl)anthracene), a carbazole-based compound (e.g., polyvinylcarbazole), an organic polysilane compound, a pyrazoline-based compound (e.g., 1-phenyl-3-(p-dimethylaminophenyl)pyrazoline), a hydrazone-based compound, an indole-based compound, an oxazole-based compound, an isoxazole-based compound, a thiazole-based compound, a thiadiazole-based compound, an imidazole-based compound, a pyrazole-based compound, and a triazole-based compound. The photosensitive layer 3 may contain only one type of the hole transport material or may contain two or more types of the hole transport materials.

In particular, any compound represented by a formula (HTM-1), a formula (HTM-2), a formula (HTM-3), and a formula (HTM-4) below is suitable as the hole transport material.

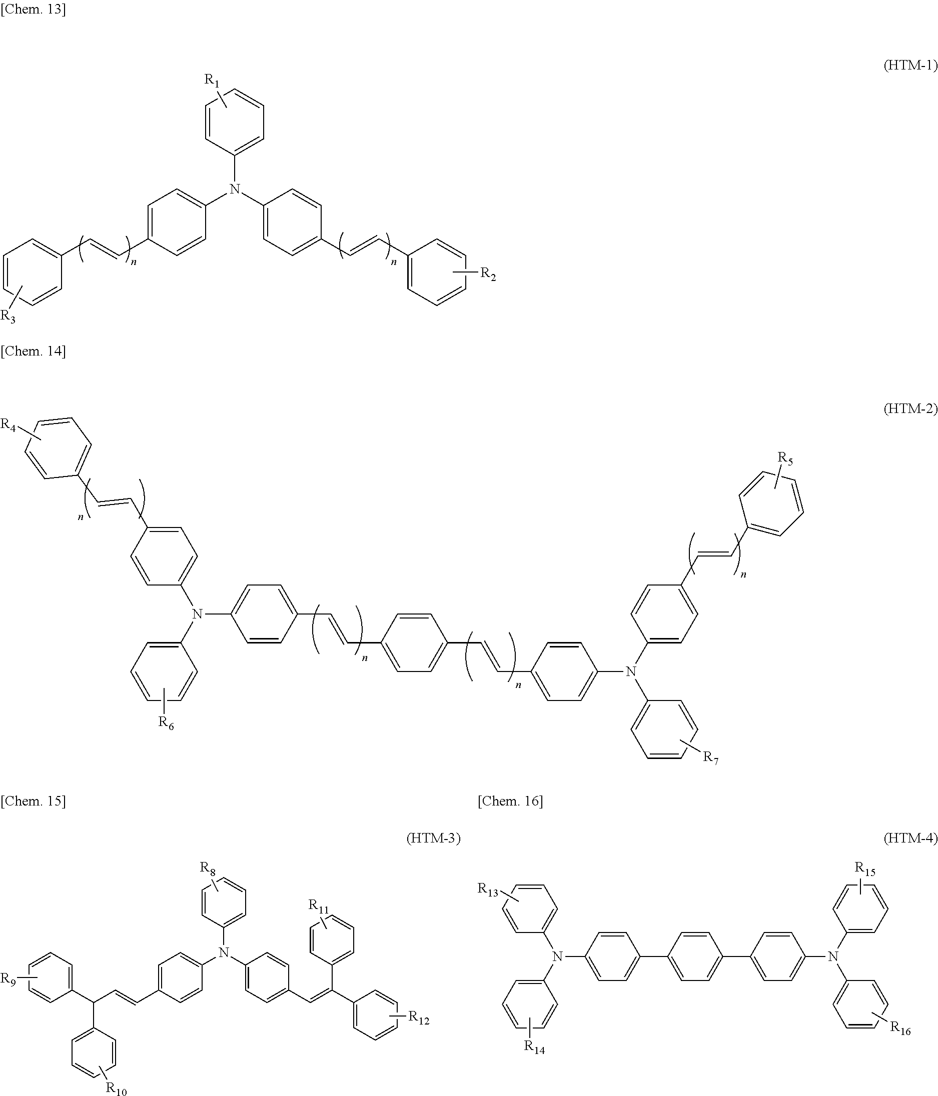

In the above formulae (HTM-1) to (HTM-4), R₁ to R₁₆ each independently represent a hydrogen atom, an alkyl group having 1 to 8 carbon atoms, or a phenyl group, and n represents a natural number of 1 or less.

Specifically, any compound represented by the following formula (HT-1), formula (HT-2), formula (HT-3), and formula (HT-4) is suitable as the hole transport material.

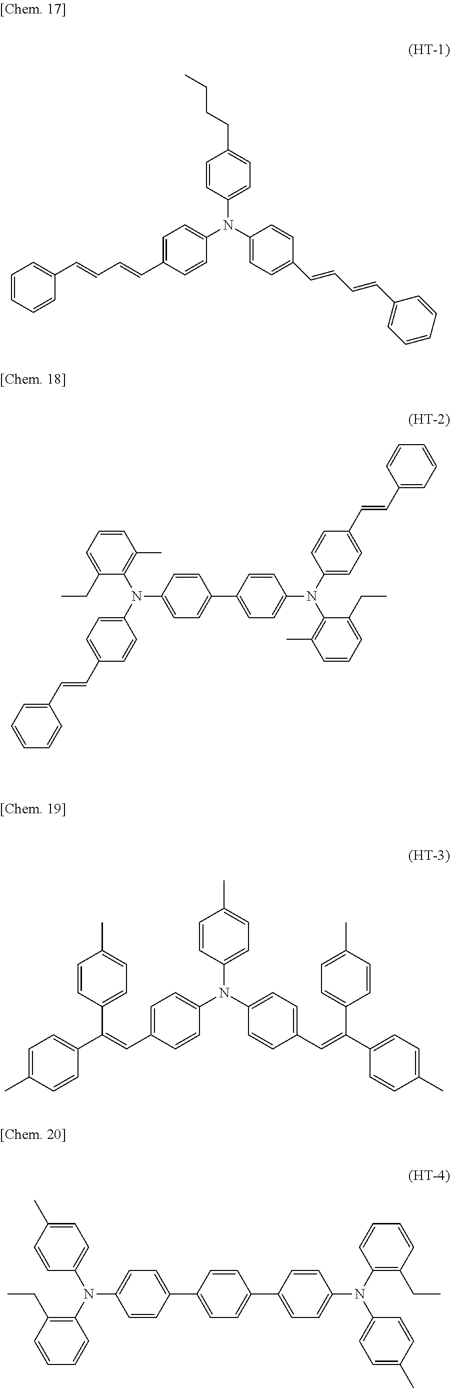

A content of the hole transport material is preferably 10 mass parts or more and 300 mass parts or less, and more preferably 10 mass parts or more and 150 mass parts or less with respect to 100 mass parts of binder resin.

### (Electron Transport Material)

Examples of the electron transport material include a quinone-based compound, a diimide-based compound, a hydrazone-based compound, a malononitrile-based compound, a thiopyran-based compound, a trinitrothioxanthon-based compound, a 3,4,5,7-tetranitro-9-fluorenone-based compound, a dinitroanthracene-based compound, a dinitroacridine-based compound, tetracyanoethylene, 2,4,8-trinitrothioxanthone, dinitrobenzene, dinitroacridine, succinic anhydride, maleic anhydride, and dibromo maleic anhydride. Examples of the quinone-based compound include a diphenoxyquinone-based compound, an azoquinone-based compound, an anthraquinone-based compound, a naphthoquinone-based compound, a nitroanthraquinone-based compound, and a dinitroanthraquinone-based compound. The photosensitive layer 3 may contain only one type of the electron transport material or may contain two or more types of the electron transport materials.

In particular, any compound represented by a formula (ETM-1), a formula (ETM-2), a formula (ETM-3), a formula (ETM-4), a formula (ETM-5), and a formula (ETM-6) below is suitable as the electron transport material.

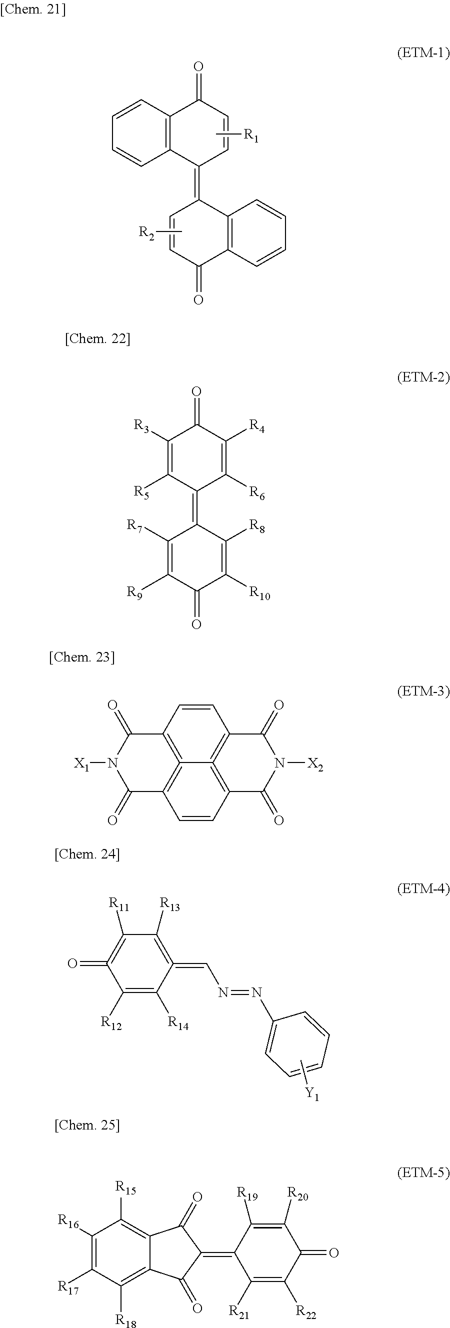

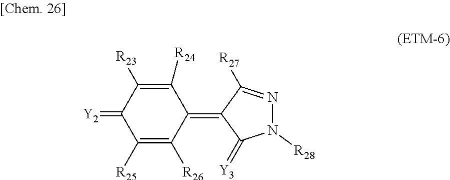

In the above formulae (ETM-1) to (ETM-6), R₁ to R₂₈ each independently represent a hydrogen atom, a halogen atom, a cyano group, or an alkyl group having 1 to 6 carbon atoms; X₁ and X₂ each independently represent an aryl group having 6 to 14 carbon atoms which may have at least one of an alkenyl group having 2 to 6 carbon atoms, an alkoxy group having 1 to 6 carbon atoms, or alkyl group having 1 to 6 carbon atoms; and Y₁ to Y₃ each independently represent a halogen group or an oxygen atom.

Specifically, any compound represented by a formula (ET-1), a formula (ET-2), a formula (ET-3), a formula (ET-4), a formula (ET-5), a formula (ET-6), and a formula (ET-7) below is suitable as the electron transport material.

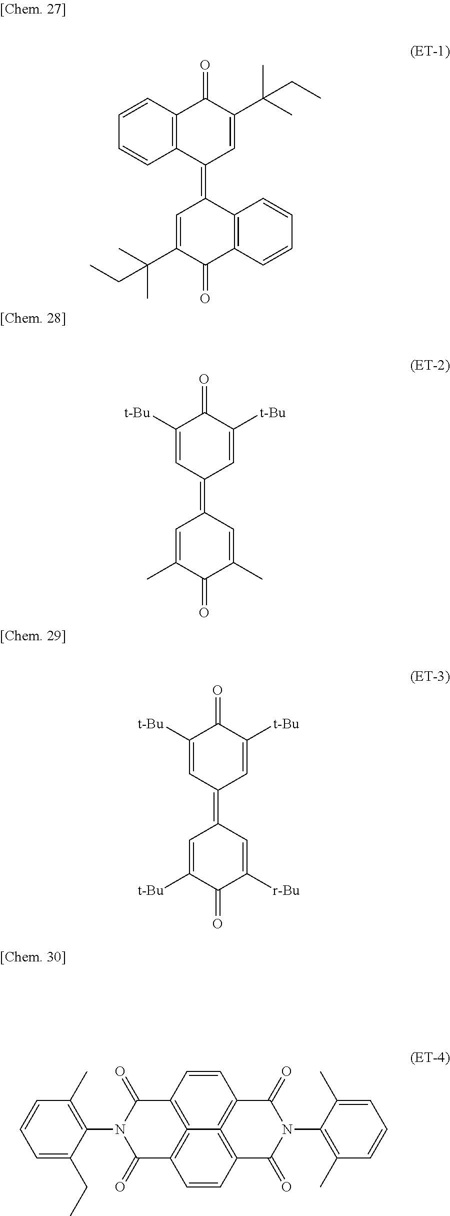

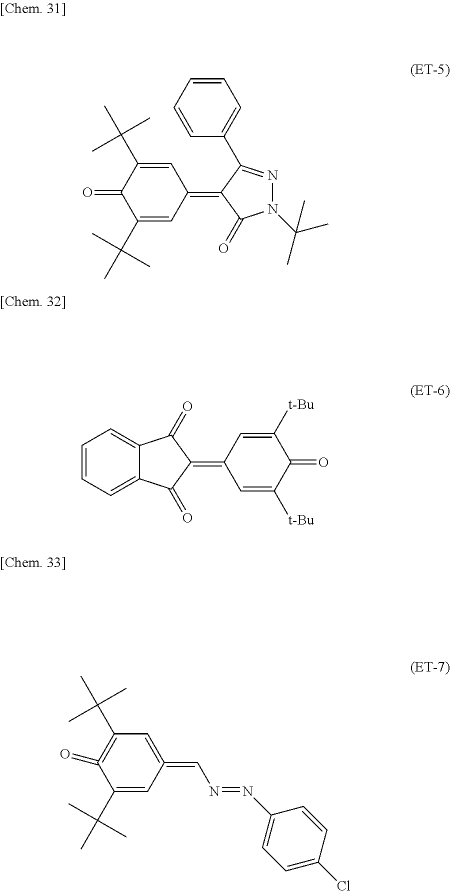

A content of the electron transport material is preferably 5 mass parts or more and 150 mass parts or less, and more preferably 10 mass parts or more and 100 mass parts or less with respect to 100 mass parts of binder resin.

### (Binder Resin)

Examples of the binder resin include a polycarbonate resin, a polyarylate resin, a styrene-based resin, a styrene-butadiene copolymer, a styrene-acrylonitrile copolymer, a styrene-maleic acid copolymer, a styrene-acrylic acid copolymer, an acrylic copolymer, a polyethylene resin, an ethylene-vinyl acetate copolymer, a chlorinated polyethylene resin, a polyvinyl chloride resin, a polypropylene resin, an ionomer, a vinyl chloride-vinyl acetate copolymer, a polyester resin, an alkyd resin, a polyamide resin, a polyurethane resin, a polysulfone resin, a diallyl phthalate resin, a ketone resin, a polyvinyl butyral resin, a polyvinyl acetal resin, a polyether resin, a silicone resin, an epoxy resin, a phenol resin, an urea resin, a melamine resin, an epoxy-acrylic acid resin, and an urethane-acrylic acid copolymer.

Specifically, as the binder resin, a polycarbonate resin can be used which has bisphenol represented by the following formula (R-1) as a monomer and DMP (dimethyl phthalate) as a terminal stopping agent.

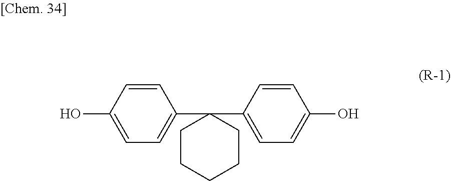 [SMILES: Oc1ccc(C2(c3ccc(O)cc3)CCCCC2)cc1]

The photosensitive layer 3 has the above configuration. In addition to the materials described above, the photosensitive layer 3 may also contain an additive. Examples of the additive include an ultraviolet absorber, an antioxidant, a radical scavenger, a singlet quencher, a softener, a surface modifier, a bulking agent, a thickener, a dispersion stabilizer, wax, a donor, a surfactant, a plasticizer, a sensitizer, and a leveling agent. The photosensitive layer 3 may contain one type or two or more types of these additives.

### [Configuration of Protective Layer]

The protective layer 4 covers and protects the photosensitive layer 3. The protective layer 4 includes a base material and n-type conductive microparticles and metal oxide microparticles dispersed within the base material.

### {Base Material}

The base material includes a graft polymer configured of a UV (ultraviolet) curable multifunctional monomer, a photopolymerization initiator, and a photoreactive group-containing substance.

### (UV Curable Multifunctional Monomer)

The UV curable multifunctional monomer is an acrylic monomer having UV curability and multiple functional groups. Specifically, as the UV curable multifunctional monomer, any compound represented by a formula (B-1), a formula (B-2), and a formula (B-3) below can be used.

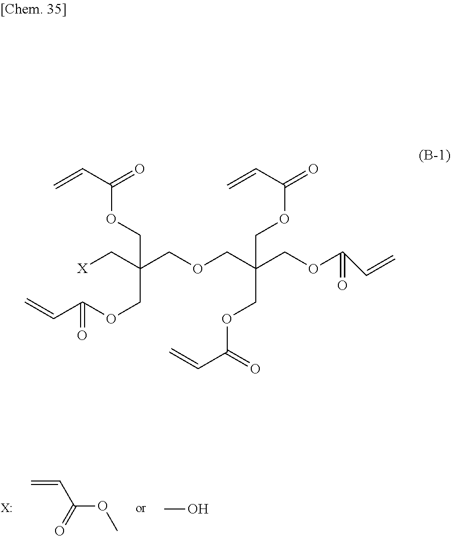

The above compound is called dipentaerythritol polyacrylate, and for example, “A-DPH” (manufactured by Shin Nakamura Chemical Co., Ltd.) can be used. This compound has five or six (meth)acrylic groups.

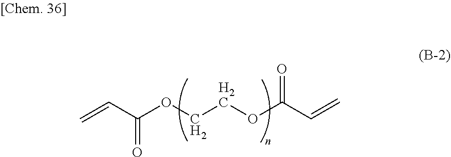

The above compound is called polyethylene glycol diacrylate, and for example, “A-200” (manufactured by Shin Nakamura Chemical Co., Ltd.) can be used. This compound has two (meth)acrylic groups.

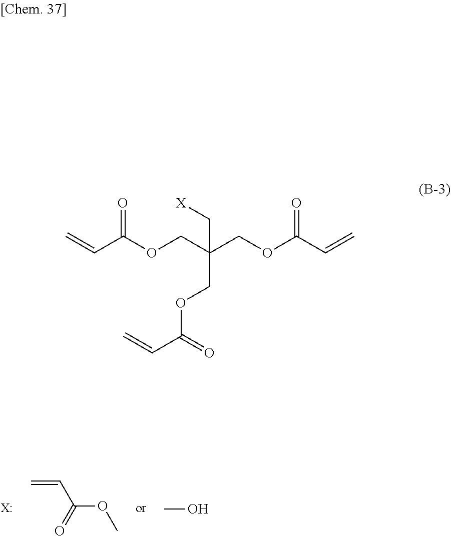

The above compound is called pentaerythritol tri- and tetra-acrylate, and for example, “A-TMM-3 LM-N” (manufactured by Shin Nakamura Chemical Co., Ltd.) can be used. This compound has three or four (meth)acrylic groups.

As the UV curable multifunctional monomer, those among the above compounds having the three or more (meth)acrylic groups are more suitable; specifically, compounds represented by a formula (B-1) and a formula (B-3) are more suitable. This is because when the UV curable multifunctional monomer has the three or more (meth)acrylic groups, hardness of the protective layer 4 increases, which prevents wear. A content of the UV curable multifunctional monomer is preferably 30 mass parts or more and 80 mass parts or less with respect to 100 mass parts of resin.

### (Photopolymerization Initiator)

The photopolymerization initiator initiates graft polymerization via photopolymerization of the UV curable multifunctional monomer and the photoreactive group-containing substance. The photopolymerization initiator may be an acylphosphine oxide represented by the following formula (P-1).

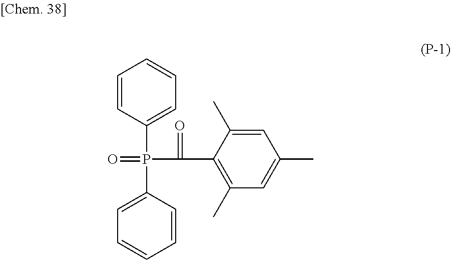 [SMILES: Cc1cc(C)c(C(=O)P(=O)(c2ccccc2)c2ccccc2)c(C)c1]

Acyl phosphine oxide, for example, “Omnirad TPO-H” (manufactured by Toyotsu Chemiplas Corporation) can be used. Other photopolymerization initiators capable of initiating the photopolymerization of the UV curable multifunctional monomer and the photoreactive group-containing substance may also be used. A content of the photopolymerization initiator is preferably 5 to 15 parts by weight with respect to 100 parts by weight of the base material.

### (Photoreactive Group-Containing Substance000)

The photoreactive group-containing substance is a monomer or a polymer having a photoreactive group. Specifically, as the photoreactive group-containing substance, a graft polymer having an organic main chain and a side chain having multiple reactive groups and a fluorine-modified silicone skeleton or silane skeleton as a release skeleton may be used. More specifically, as the photoreactive group-containing substance, any compound represented by a formula (C-1), a formula (C-2), a formula (C-3), and a formula (C-4) below can be used.

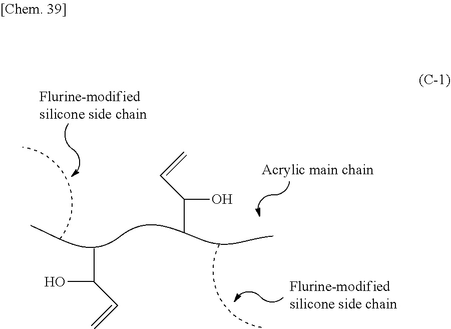

The above compound is a silicone/fluorine-modified acrylic polymer having an acrylic main chain and a fluorine-modified silicone side chain. An example of this compound is “8FS-001” (manufactured by Taisei Fine Chemical Co., Ltd.).

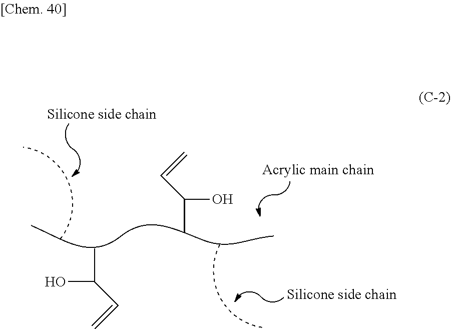

The above compound is a silicone-modified acrylic polymer having an acrylic main chain and a silicone side chain. An example of this compound is “8SS-723” (manufactured by Taisei Fine Chemical Co., Ltd.).

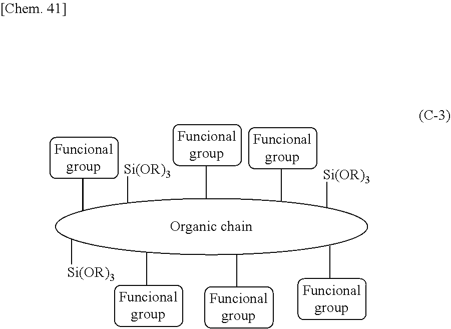

The above compound is a multifunctional acrylic silane having an organic chain, a functional group, and an alkoxysilyl group (Si(OR)3). An example of this compound is “X-12-1050” (manufactured by Shin-Etsu Chemical Co., Ltd.).

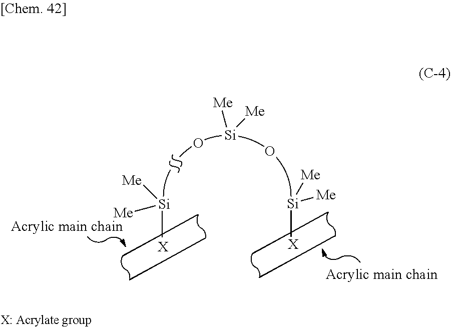

The above compound is a silicone having a silane backbone and acrylate groups at both ends. For example, “KP-423” (manufactured by Shin-Etsu Chemical Co., Ltd.) can be used.

A content of the photoreactive group-containing substance is preferably 0.1 mass part or more and 50 mass parts or less with respect to 100 mass parts of the base.

{n-Type Conductive Microparticles}

The n-type conductive microparticles are microparticles including n-type conductive materials. Examples of the n-type conductive materials include an indium-doped tin oxide and an antimony-doped tin oxide. The n-type conductive microparticles are preferably those with a primary particle size of 10 nm or more and 500 nm or less. A content of the n-type conductive microparticles is preferably 1 mass part or more and 10 mass parts or less with respect to 100 mass parts of the base material.

### {Metal Oxide Microparticles}

The metal oxide microparticles are particles including metal oxides. Examples of the metal oxides include a tin oxide, a zinc oxide, a titanium oxide, alumina, and silica. The metal oxide microparticles are preferably those with a primary particle size of 10 nm or more and 500 nm or less. A content of the metal oxide microparticles is preferably 1 part by mass or more and 10 parts by mass or less per 100 parts by mass of the base material.

Table 1 below shows examples of the n-type conductive microparticles and the metal oxide microparticles.

TABLE 1

| | | | | Specific | Primary | Volume |
|---|---|---|---|---|---|---|
| | | | | surface | particle | resistivity |
| | | | | area | size | Ω · |
| | | Product name | Manufacturer | m²/g | nm | cm |
| 1 | Tin oxide | S-2000 | Mitsubishi Materials Electronic | 45-60 | | 10.6 |
| | | | Chemicals Co., Ltd. | | | |
| 2 | Phosphorus- | SP-2 | Mitsubishi Materials Electronic | 80-130 | | 9.4 |
| | doped tin oxide | | Chemicals Co., Ltd. | | | |
| 3 | Antimony-doped | T-1 | Mitsubishi Materials Electronic | 70-85 | 200 | 9.8 |
| | tin oxide | | Chemicals Co., Ltd. | | | |
| 4 | Zinc oxide | NanoTek ZnO | C.I. TAKIRON | | 65.9 | 15.2 |
| | | | Corporation | | | |
| 5 | Titanium oxide | MT-500B | Tayca Corporation | | 40 | 14.1 |
| 6 | Alumina | Nanotak Al₂ O₃ | C.I. TAKIRON | 55 | 31 | 12.5 |
| | | | Corporation | | | |
| 7 | Silica | Nanotek SiO₂ | C.I. TAKIRON | 110 | 11 | 13.5 |
| | | | Corporation | | | |
| 8 | Silicone | MSP-N050 | Nikko Rica | | 500 | 14.2 |
| | | | Corporation | | | |

### {Regarding Protective Layer}

As described later, the protective layer 4 is formed by irradiating light onto a solution containing a UV curable multifunctional monomer, the photopolymerization initiator, a photoreactive group-containing substance, the n-type conductive microparticles, and the metal oxide microparticles, thereby inducing photopolymerization. The protective layer 4 has a Martens hardness of 400 N/mm² or more and a volume resistivity of 1.0×10¹⁰ Ω·cm or more. The Martens hardness is measured according to the method specified in ISO 14577. The volume resistivity is measured by pressing an electrode probe of a resistivity meter onto the protective layer 4 and applying a voltage of 100 V for 10 seconds. The protective layer 4 has the above configuration. The protective layer 4 may contain the additive in addition to the materials described above. Examples of the additive include the ultraviolet absorber, the antioxidant, the plasticizer, the surface modifier, the bulking agent, the thickener, the dispersion stabilizer, and the leveling agent. The protective layer 4 may contain one type or two or more types of these additives.

### [Configuration of Undercoat Layer]

The undercoat layer 5 maintains an insulating state sufficient to suppress leakage while facilitating a flow of charges (of opposite polarity to charges transported to photosensitive member surface) from the photosensitive layer 3 to the conductive base 2 and suppressing an increase in resistance.

The undercoat layer 5 contains, for example, inorganic particles and the binder resin. As the inorganic particles, particles including, for example, a metal (e.g., aluminum, iron, or copper), a metal oxide (e.g., titanium oxide, alumina, zirconium oxide, tin oxide, or zinc oxide), or a non-metal oxide (e.g., silica) can be used. The binder resin may be the same binder resin listed as the material for the photosensitive layer 3. A content of the inorganic particles is preferably 1 mass part or more and 10 mass parts or less with respect to 100 mass parts of binder resin. As shown in FIG. 1, the undercoat layer 5 may not necessarily be provided.

### <Method for Manufacturing Single-Layered Electrophotographic Photosensitive Member>

A method for manufacturing the electrophotographic photosensitive member 1 will be described. The electrophotographic photosensitive member 1 can be formed by sequentially laminating the undercoat layer 5, the photosensitive layer 3, and the protective layer 4 onto the conductive base 2 (see FIG. 2).

The undercoat layer 5 can be formed on the conductive base 2 by preparing a coating solution in which a solvent, the inorganic particles, and the binder resin are mixed, coating this coating solution to the conductive base 2, and removing the solvent. Mixing of the materials can be performed using, for example, a bead mill, a roll mill, a ball mill, an attritor, a paint shaker, a rod-type ultrasonic oscillator, or an ultrasonic disperser.

The solvent may be any of being capable of dissolving the binder resin, such as alcohols (specifically, methanol, ethanol, isopropanol, and butanol, etc.), aliphatic hydrocarbons (specifically, n-hexane, octane, and cyclohexane, etc.), aromatic hydrocarbons (specifically, benzene, toluene, and xylene, etc.), halogenated hydrocarbons (specifically, dichloromethane, dichloroethane, carbon tetrachloride, and chlorobenzene, etc.), ethers (specifically, dimethyl ether, diethyl ether, tetrahydrofuran, ethylene glycol dimethyl ether, and diethylene glycol dimethyl ether, etc.), ketones (specifically, acetone, methyl ethyl ketone, and cyclohexanone, etc.), esters (specifically, ethyl acetate and methyl acetate, etc.), dimethylformaldehyde, dimethylformamide, and dimethyl sulfoxide.

The coating solution may be coated using any method capable of uniformly coating the coating solution, such as a dip coating method, a spray coating methos, a spin coating method, and a bar coating method. The solvent may be removed by heating, pressure reduction, or a combination of heating and pressure reduction, specifically using a high-temperature dryer or a reduced-pressure dryer.

The photosensitive layer 3 can be formed on the undercoat layer 5 by preparing the coating solution in which the solvent, the charge generation material, the hole transport material, the electron transport material, and the binder resin are mixed, coating this coating solution onto the undercoat layer 5, and removing the solvent. The method for mixing the material, coating the solvent, and removing the solvent can be those described for forming the undercoat layer 5.

The protective layer 4 can be formed on the photosensitive layer 3 by preparing the coating solution in which the solvent, the UV curable multifunctional monomer, the photopolymerization initiator, the photoreactive group-containing substance, the n-type conductive microparticles, and the metal oxide microparticles are mixed, coating this coating solution onto the photosensitive layer 3, and irradiating the coating solution with light. Upon the light irradiation, the UV curable multifunctional monomer, the photopolymerization initiator, and the photoreactive group-containing substance undergo the photopolymerization, forming the base material. The method for mixing the material, coating the solvent, and removing the solvent can be those described for forming the undercoat layer 5. For the light irradiation, light with a wavelength of 365 nm is preferred, and the light irradiation can be performed using an LED (light emitting diode) light source with an emission wavelength of 365 nm.

The electrophotographic photosensitive member 1 can be manufactured as described above. Note that the electrophotographic photosensitive member 1 including no undercoat layer 5 (see FIG. 1) can be manufactured by forming the photosensitive layer 3 directly on the conductive base 2 without performing a step of forming the undercoat layer 5.

### <Effects of Electrophotographic Photosensitive Member>

Effects of the electrophotographic photosensitive member 1 are described below. As described above, the electrophotographic photosensitive member 1 has the protective layer 4 covering the photosensitive layer 3. The protective layer 4 includes the base material formed from the graft polymer configured of the curable multifunctional monomer, the photopolymerization initiator, and the photoreactive group-containing substance. This results in a surface of the protective layer 4 (i.e., photosensitive member surface) having increased slip properties and hardness (specifically, Martens hardness of 400 N/mm² or more). This increases the slip properties and the hardness of the photosensitive member surface, thereby improving the wear resistance of the electrophotographic photosensitive member 1.

Furthermore, since the protective layer 4 includes the n-type conductive microparticles and the metal oxide microparticles dispersed within the base material, it can suppress the image bleeding in the electrophotographic photosensitive member. While the n-type conductive microparticles with excellent electron transport properties ensure the electrical characteristics of the electrophotographic photosensitive member 1, they can cause charging defects due to reduced resistance. Therefore, mixing the metal oxide microparticles increases the resistance of the protective layer 4 (specifically, volume resistivity of 1.0×10¹⁰ Ω·cm or more), preventing the image bleeding.

Thus, the electrophotographic photosensitive member 1 enables realization of the electrophotographic photosensitive member with excellent wear resistance and suppressed image bleeding. Specifically, by using the graft polymer having a fluorine-modified silicone backbone or silane backbone in the side chain as the photoreactive group-containing substance, the slip properties of the photosensitive member surface is further improved, enabling realization of the electrophotographic photosensitive member 1 with even greater wear resistance. Furthermore, since the graft polymer has water repellency, the protective layer 4 becomes a low-moisture-absorption film, enabling greater suppression of the image bleeding.

### <Configuration of Multi-Layered Electrophotographic Photosensitive Member>

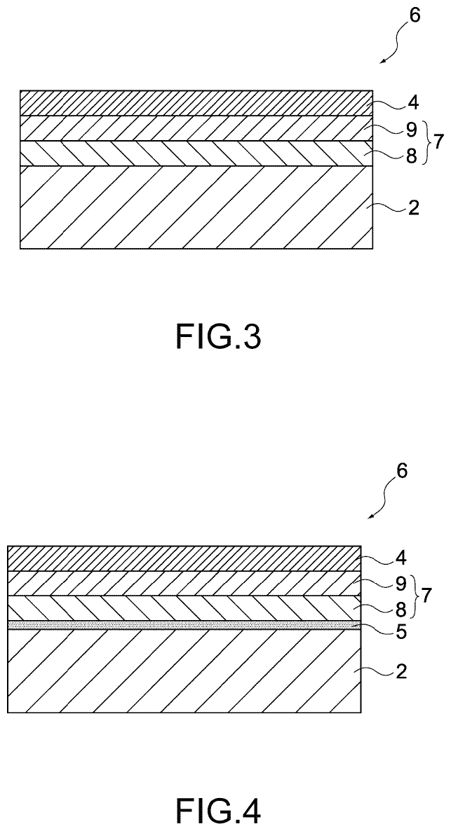

FIG. 3 is a schematic diagram of a multi-layered electrophotographic photosensitive member 6 according to this embodiment. As shown in FIG. 3, the electrophotographic photosensitive member 6 includes the conductive base 2, the photosensitive layer 7, and the protective layer 4. The photosensitive layer 7 includes a charge generation layer 8 and a charge transport layer 9. The charge generation layer 8 is provided on the conductive base 2, and the charge transport layer 9 is provided on the charge generation layer 8. The protective layer 4 is provided on the charge transport layer 9. The electrophotographic photosensitive member 6 is a multi-layered electrophotographic photosensitive member having the photosensitive layer 7 including two layers of the charge generation layer 8 and the charge transport layer 9. Regarding configurations of the electrophotographic photosensitive member 6 other than the photosensitive layer 7, it is identical to those of the electrophotographic photosensitive member 1. Therefore, the same reference numerals as those used for the electrophotographic photosensitive member 1 are used, and the description is omitted.

The electrophotographic photosensitive member 6 may also further include the undercoat layer. FIG. 4 is a schematic diagram of the electrophotographic photosensitive member 6 with the undercoat layer 5. As shown in FIG. 4, the undercoat layer 5 is provided between the conductive base 2 and the charge generation layer 8.

A thickness of each layer is not particularly limited, but a thickness of the photosensitive layer 7 is preferably 10 μm or more and 200 μm or less. Among these, a thickness of the charge generation layer 8 is preferably 5 μm or more and 100 μm or less, and a thickness of the charge transport layer 9 is preferably 5 μm or more and 100 μm or less.

### [Configuration of Photosensitive Layer]

The photosensitive layer 7 transports positive charges generated by the light absorption to the surface of the electrophotographic photosensitive member 6 (hereinafter referred to as photosensitive member surface). In the electrophotographic photosensitive member 6, charges are generated in the charge generation layer 8, and the charge transport layer 9 transports the generated charges to the photosensitive member surface.

The charge generation layer 8 contains a charge generation material and the binder resin. For both the charge generation material and the binder resin, the materials described in the configuration of the photosensitive layer 3 above can be used. The charge transport layer 9 contains a hole transport material and the binder resin. For both the hole transport material and the binder resin, the materials described in the configuration of the photosensitive layer 3 above can be used.

The photosensitive layer 7 has the above configuration. The charge generation layer 8 and the charge transport layer 9 may each contain the additive in addition to the materials described above. Examples of the additive include the ultraviolet absorber, the antioxidant, the radical scavenger, the singlet quencher, the plasticizer, the surface modifier, the bulking agent, the thickening agent, the dispersion stabilizer, wax, the donor, the surfactant, the plasticizer, the sensitizer, and the leveling agent. The charge generation layer 8 and charge transport layer 9 may contain one type or two or more types of these additives.

The electrophotographic photosensitive member 6 has the above configuration. The protective layer 4, similar to the electrophotographic photosensitive member 1, includes the base material and the n-type conductive microparticles and the metal oxide microparticles dispersed within the base material. The base material includes the graft polymer configured of the UV curable multifunctional monomer, the photopolymerization initiator, and the photoreactive group-containing substance. The undercoat layer 5 also contains the inorganic particles and the binder resin, similar to the electrophotographic photosensitive member 1.

### <Method for Manufacturing Multi-Layered Electrophotographic Photosensitive Member>

A method for manufacturing the electrophotographic photosensitive member 6 will be described. The electrophotographic photosensitive member 6 can be formed by laminating, in this order, the undercoat layer 5, the charge generation layer 8, the charge transport layer 9, and the protective layer 4 onto the conductive base 2 (see FIG. 4). The undercoat layer 5 can be formed in the same manner as described above for the electrophotographic photosensitive member 1.

The charge generation layer 8 can be formed on the undercoat layer 5 by preparing the coating solution in which the solvent, the charge generation material, and the binder resin are mixed, coating this coating solution onto the undercoat layer 5, and removing the solvent. The method for mixing the material, coating the solvent, and removing the solvent can be those described for forming the undercoat layer 5.

The charge transport layer 9 can be formed on the charge generation layer 8 by preparing the coating solution in which the solvent, the hole transport material, and the binder resin are mixed, coating this coating solution onto the charge generation layer 8, and removing the solvent. The method for mixing the material, coating the solvent, and removing the solvent can be those described for forming the undercoat layer 5.

The protective layer 4 can be formed on the photosensitive layer 3 by preparing the coating solution in which the solvent, the UV curable multifunctional monomer, the photopolymerization initiator, the photoreactive group-containing substance, the n-type conductive microparticles, and the metal oxide microparticles are mixed, coating this coating solution onto the charge transport layer 9, and irradiating the coating solution with light. Upon the light irradiation, the UV curable multifunctional monomer, the photopolymerization initiator, and the photoreactive group-containing substance undergo the photopolymerization, forming the base material. The method for mixing the material, coating the solvent, and removing the solvent can be those described for forming the undercoat layer 5. For the light irradiation, light with a wavelength of 365 nm is preferred, and the light irradiation can be performed using the LED (light emitting diode) light source with an emission wavelength of 365 nm.

The electrophotographic photosensitive member 1 can be manufactured as described above. Note that the electrophotographic photosensitive member 6 including no undercoat layer 5 (see FIG. 3) can be manufactured by forming the charge generation layer 8 directly on the conductive base 2 without performing the step of forming the undercoat layer 5.

### <Effects of Electrophotographic Photosensitive Member>

The electrophotographic photosensitive member 6 has the same effects as the electrophotographic photosensitive member 1. Specifically, since the surface of the protective layer 4 (i.e., photosensitive member surface) has high slip properties and high hardness, the electrophotographic photosensitive member 6 exhibits excellent wear resistance. Furthermore, since the protective layer 4 contains the n-type conductive microparticles and the metal oxide microparticles dispersed within the base material, the resistance of the protective layer 4 is high, suppressing the image bleeding.

### [Configuration of Image Forming Apparatus]

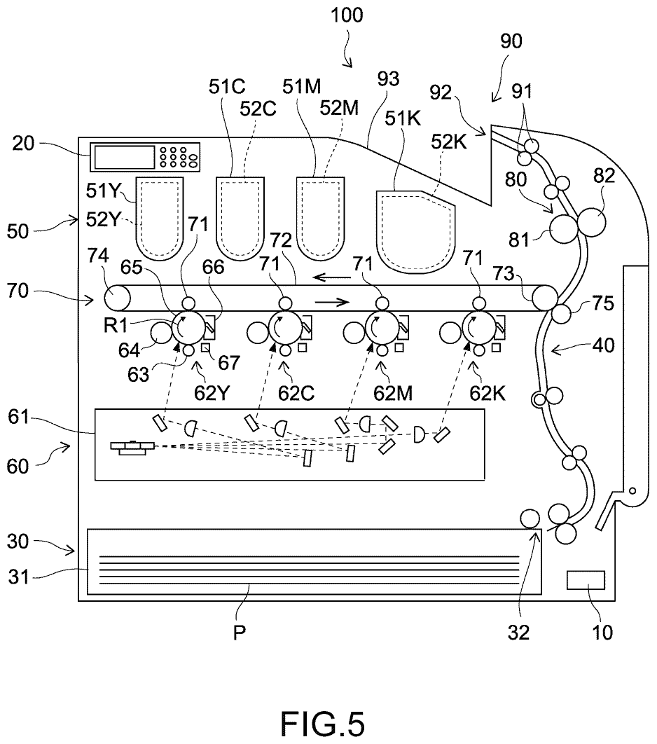

An image forming apparatus 100 according to an embodiment of the present disclosure will be described. FIG. 5 is a schematic diagram showing a configuration of the image forming apparatus 100. The image forming apparatus 100 is, for example, a tandem type color printer.

As shown in FIG. 5, the image forming apparatus 100 includes a control unit 10, an operation unit 20, a paper feed unit 30, a transport unit 40, a toner supply unit 50, an image forming unit 60, a transfer device 70, a fixing device 80, and an ejection unit 90.

The control unit 10 controls an action of each unit provided in the image forming apparatus 100. The control unit 10 includes an arithmetic processing unit and a memory unit (not shown). The arithmetic processing unit is, for example, a CPU (central processing unit), and the memory unit is, for example, a semiconductor memory or an HDD (hard disk drive). The arithmetic processing unit controls the action of the image forming apparatus 100 by executing a control program. The memory unit stores the control program.

The operation unit 20 receives an instruction from a user. When the operation unit 20 receives the instruction from the user, it sends a signal indicating the instruction from the user to the control unit 10. This initiates an image forming action by the image forming apparatus 100.

The paper feed unit 30 includes a paper feed cassette 31 and a paper feed roller group 32. The paper feed cassette 31 can hold several pieces of recording media P. The recording media P are, for example, printing paper. The paper feed roller group 32 feeds the recording media P held in the paper feed cassette 31 one by one to the transport unit 40.

The transport unit 40 includes rollers and guide members. The transport unit 40 extends from the paper feed unit 30 to the ejection unit 90. The transport unit 40 transports the recording medium P from the paper feed unit 30 to the ejection unit 90, passing through the image forming unit 60 and the fixing device 80.

The toner supply unit 50 supplies toner to the image forming unit 60. The toner supply unit 50 includes a first mounting portion 51Y, a second mounting portion 51C, a third mounting portion 51M, and a fourth mounting portion 51K. A first toner container 52Y is mounted on the first mounting portion 51Y. A second toner container 52C is mounted on the second mounting portion 51C, a third toner container 52M is mounted on the third mounting portion 51M, and a fourth toner container 52K is mounted on the fourth mounting portion 51K.

The first toner container 52Y holds yellow toner, and the second toner container 52C holds cyan toner. The third toner container 52M holds magenta toner, and the fourth toner container 52K holds black toner. Note that a color of the toner is not limited to be shown here and may be other colors. The number of colors may also be one or more.

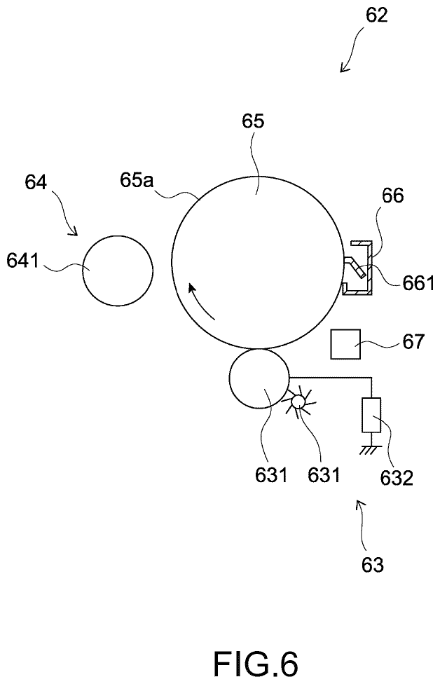

The image forming unit 60 includes an exposure device 61, a first image forming unit 62Y, a second image forming unit 62C, a third image forming unit 62M, and a fourth image forming unit 62K. FIG. 6 is a schematic diagram of the image forming unit 62. The first image forming unit 62Y, the second image forming unit 62C, the third image forming unit 62M, and the fourth image forming unit 62K each have a configuration of the image forming unit 62 shown in FIG. 6. The image forming unit 62 includes a charging device 63, a developing device 64, a photosensitive member 65, a cleaning device 66, and a static elimination device 67. The charging device 63, the developing device 64, the cleaning device 66, and the static elimination device 67 are arranged along a surface 65a of the photosensitive member 65.

The exposure device 61 (see FIG. 5) irradiates light (shown as dashed lines in FIG. 5) onto the surface 65a of the photosensitive member 65 provided in each image forming unit 62, thereby exposing the surface 65a. The exposure device 61 irradiates light for each color onto each image forming unit 62 based on supplied image data and performs exposure. The exposure device 61 can perform the exposure using laser light.

The photosensitive member 65 forms an electrostatic latent image when exposed by the exposure device 61. The photosensitive member 65 may be the single-layered electrophotographic photosensitive member 1 or the multi-layered electrophotographic photosensitive member 6 described above. The surface of the protective layer 4 provided on the electrophotographic photosensitive member 1 and the electrophotographic photosensitive member 6 is defined as the surface 65a of the photosensitive member 65. The surface 65a is positively or negatively charged in advance. When the surface 65a is exposed by the exposure device 61, the charge decays in the areas where light is irradiated, forming the electrostatic latent image. The photosensitive member 65 rotates in the direction (clockwise direction) indicated by the arrow shown in FIG. 6.

The charging device 63 positively or negatively charges the surface 65a. The charging device 63 includes a charging roller 631, a charging voltage power supply 632, and a cleaning brush 633. The charging roller 631 contacts the surface 65a to uniformly charge it. The charging voltage power supply 632 applies a charging voltage to the charging roller. This charging voltage is preferably a DC voltage. The cleaning brush 633 contacts the charging roller 631 and cleans the charging roller 631.

The developing device 64 feeds the toner supplied from the toner supply unit 50 to the surface 65a. As shown in FIG. 6, the developing device 64 includes a developing roller 641. The toner supplied from the toner container is mixed with a magnetic carrier to form a two-component developer. During this mixing, the toner becomes charged with the same polarity as the surface 65a due to friction with the carrier.

The two-component developer is attracted to the developing roller 641 by magnetic force and transported to a position facing the photosensitive member 65. A voltage is applied between the developing roller 641 and the photosensitive member 65, causing the toner in the two-component developer to adhere to the electrostatic latent image on the surface 65a. This forms a toner image on the surface 65a that corresponds to the electrostatic latent image.

The developing device 64 of the first image forming unit 62Y is connected to the first toner container 52Y, from which the yellow toner is supplied. Consequently, a yellow toner image is formed on the surface of the photosensitive member 65 included in the first image forming unit 62Y. Similarly, the developing device 64 included in the second image forming unit 62C is connected to the second toner container 52C, and a cyan toner image is formed on the surface of the photosensitive member 65 included in the second image forming unit 62C.

Furthermore, the developing device 64 included in the third image forming unit 62M is connected to the third toner container 52M, and a magenta toner image is formed on the surface of the photosensitive member 65 included in the third image forming unit 62M. The developing device 64 included in the fourth image forming unit 62K is connected to the fourth toner container 52K, and a black toner image is formed on the surface of the photosensitive member 65 included in the fourth image forming unit 62K.

The cleaning device 66 recovers the toner adhering to the surface 65a after transfer by the primary transfer roller 71 described later. Specifically, the cleaning device 66 includes a cleaning blade 661 and the static elimination device 67. The cleaning blade 661 is pressed against the surface 65a and cleans it by recovering the toner adhering to the surface 65a. The static elimination device 67 eliminates static electricity on the surface 65a by irradiating it with static elimination light.

The transfer device 70 (see FIG. 5) transfers the toner image from the photosensitive member 65 to the recording medium P, which is a transfer target. Specifically, the transfer device 70 transfers each color toner image formed on the surface 65a of the photosensitive member 65 included in each image forming unit 62, onto the recording medium P in a superimposed manner. The transfer device 70 can transfer each toner image onto the recording medium P in the superimposed manner using a secondary transfer method (intermediate transfer method). As a configuration for the secondary transfer method, the transfer device 70 includes four primary transfer rollers 71, an intermediate transfer belt 72, a drive roller 73, a follower roller 74, and a secondary transfer roller 75.

The intermediate transfer belt 72 is an endless belt stretched over the four primary transfer rollers 71, the drive roller 73, and the follower roller 74. The intermediate transfer belt 72 is driven in response to a rotation of the drive roller 73. In FIG. 5, the intermediate transfer belt 72 circulates in the direction indicated by the arrow in FIG. 5 (counterclockwise). The follower roller 74 is rotationally driven in response to the drive of the intermediate transfer belt 72.

Each image forming unit 62 faces an underside of the intermediate transfer belt 72 and is arranged in the order of the first image forming unit 62Y to the fourth image forming unit 62K, from an upstream side to a downstream side relative to a driving direction of the underside of the intermediate transfer belt 72.

Each primary transfer roller 71 is positioned facing each photosensitive member 65 via the intermediate transfer belt 72 and presses against each photosensitive member 65. Consequently, the toner image formed on the surface 65a of each photosensitive member 65 is sequentially transferred to the intermediate transfer belt 72 by each primary transfer roller 71. In the configuration of FIG. 5, the yellow toner image, the cyan toner image, the magenta toner image, and the black toner image are, in this order, transferred onto the intermediate transfer belt 72 in the superimposed manner, however, the order of the toner images is not limited to this. Hereinafter, the toner image formed by laminating the yellow toner image, the cyan toner image, the magenta toner image, and the black toner image is referred to as a “laminated toner image”.

The secondary transfer roller 75 is positioned facing the drive roller 73 via the intermediate transfer belt 72. The secondary transfer roller 75 is pressed against the drive roller 73. This creates a transfer nip (contact area) between the secondary transfer roller 75 and the drive roller 73. As the recording medium P passes through the transfer nip, the laminated toner image on the intermediate transfer belt 72 is transferred onto the recording medium P by the secondary transfer roller 75. A lamination order of the laminated toner image on the recording medium P is the reverse of a laminating order of the laminated toner image on the intermediate transfer belt 72. The recording medium P, with the laminated toner image transferred, is transported by the transport unit 40 toward the fixing device 80.

The fixing device 80 fixes the laminated toner image onto the recording medium P. The fixing device 80 includes a heating member 81 and a pressure member 82. The heating member 81 and the pressure member 82 are arranged facing each other, forming a fixing nip. The recording medium P transported from the image forming unit 60 is heated to a predetermined fixing temperature and pressed as it passes through the fixing nip, causing the laminated toner image to be fixed to the recording medium P. The recording medium P is transported by the transport unit 40 from the fixing device 80 toward the ejection unit 90.

The ejection unit 90 ejects the recording medium P with the laminated toner image fixed. The ejection unit 90 has a pair of ejection rollers 91, an ejection port 92, and an ejection tray 93. The pair of the ejection rollers 91 transports the recording medium P to the ejection tray 93 via the ejection port 92.

An image forming method by the image forming apparatus 100 will be described. When the control unit 10 acquires image data and the operation unit 20 receives a user instruction to start an image forming action, the photosensitive member 65 is rotated and driven in each image forming unit 62, and the charging roller 631 uniformly charges the surface 65a. An image forming apparatus where the surface 65a is positively charged is called a positive charging method, and an image forming apparatus where the surface 65a is negatively charged is called a negative charging method.

Next, the exposure device 61 exposes the surface 65a of each image forming unit 62 according to the image data, forming the electrostatic latent image for each color on the surface 65a. Specifically, the charges generated by the exposure are transported to the surface 65a, and the electrostatic latent image is formed as the charges cause charging to decay. In the positive charging method, electrons generated by the exposure are transported to the surface 65a, decaying the positive charging. In the negative charging method, holes generated by the exposure are transported to the surface 65a, decaying the negative charging.

The developing device 64 of each image forming unit supplies the toner of each color to the surface 65a, where it electrostatically adheres to the electrostatic latent image for that color. This forms the toner image of each color on the surface 65a of each photosensitive member 65. If an amount of the toner filled within each developing device 64 falls below a predetermined value due to toner image formation, the toner is supplied to each developing device 64 from the first toner container 52Y to the fourth toner container 52K.

An electric field is applied between the primary transfer roller 71 and the photosensitive member 65 at a predetermined transfer voltage by the primary transfer roller 71. This causes the toner image of each color on the surface 65a to be primarily transferred onto the intermediate transfer belt 72. The toner image of each color is laminated, forming the laminated toner image on the intermediate transfer belt 72. Subsequently, to prepare for the formation of a new electrostatic latent image, the toner and other residues remaining on the surface 65a after the primary transfer are removed by the cleaning device 66.

As the intermediate transfer belt 72 rotates in a counterclockwise direction by the rotation of the drive roller 73, the transport unit 40 transports the recording medium P to the transfer nip between the secondary transfer roller 75 and the drive roller 73 at a predetermined timing. The laminated toner image on the intermediate transfer belt 72 is then secondarily transferred onto the recording medium P. The recording medium P, with the laminated toner image secondary transferred, is transported by the transport unit 40 to the fixing device 80.

The recording medium P transported to the fixing device 80 is heated and pressed by the heating member 81 and the pressing member 82, causing the laminated toner image to be fixed to the surface of the recording medium P, thereby forming a color image on the recording medium P. The recording medium P with the formed color image is ejected to the ejection tray 93 at the ejection unit 90.

The image forming apparatus 100 has the above configuration. The configuration of the image forming apparatus according to the present disclosure is not limited to the above description, it may include the photosensitive member 65 having the configuration of the electrophotographic photosensitive member 1 or the electrophotographic photosensitive member 6. For example, while the image forming apparatus 100 is described as capable of forming the color image, the image forming apparatus according to the present disclosure may also be an image forming apparatus capable of forming a monochrome image. In this case, the image forming apparatus need only be equipped with a single image forming unit.

Furthermore, although the developing device 64 is described as the two-component developing system supplying the two-component developer to the surface 65a, it may also be a one-component developing system supplying a one-component developer to the surface 65a. The one-component developer is a developer formed solely of the toner, without the toner being mixed with the carrier. Moreover, the developing device 64 may also be a rub roller system including a roller that rubs the surface 65a.

Furthermore, although the image forming apparatus 100 is described as a tandem type image forming apparatus, the image forming apparatus according to the present disclosure may be a rotary type image forming apparatus. Moreover, although the image forming apparatus 100 is described as a touchdown development type image forming apparatus, the image forming apparatus according to the present disclosure may be an image forming apparatus using a development method other than the touchdown development method.

Furthermore, although the image forming apparatus 100 is an intermediate transfer type image forming apparatus, the image forming apparatus according to the present disclosure may be a direct transfer type image forming apparatus. In this case, the toner image is directly transferred from the photosensitive member 65 to the recording medium P while the photosensitive member 65 is in contact with the recording medium P.

### [Configuration of Process Cartridge]

The process cartridge according to an embodiment of the present disclosure will be described. The process cartridge according to this embodiment corresponds to part or all of the image forming unit 62 described above (see FIG. 6) and includes at least the photosensitive member 65. Furthermore, the process cartridge according to this embodiment may include at least one of the charging device 63, the developing device 64, the cleaning device 66, and the static elimination device 67, in addition to the photosensitive member 65.

The process cartridge is configured to be attachable/detachable to/from the image forming apparatus 100. This allows the entire process cartridge to be easily replaced, for example, when sensitivity characteristics of the photosensitive member 65 deteriorate.

### Example

Each electrophotographic photosensitive member according to Examples and Comparative Examples of the present disclosure was produced, and various physical property values were measured. Tables 2 through 5 below show configurations of the electrophotographic photosensitive members according to Examples and Comparative Examples.

TABLE 2

| | | Protective layer | | | | | | | | | | | | |
|---|---|---|---|---|---|---|---|---|---|---|---|---|---|---|
| | Photo- | | | | UV curable | | | Photoreactive group-containing substance | | | | | | |
| | sensitive | | | | multifunctional | | | | Main | | | Water | | Film |
| | layer | Con- | Microparticles | | monomer | | | | chain | photo- | Water | repellant | | thick- |
| | Configu- | figu- | n-type | metal | Main | Funcional | | Main | skele- | reactive | repellent | group | | ness |
| | ration | ration | conductive | oxide | skeleton | group(X) | Ratio | skeleton | ton | group | group | skeleton | Ratio | (μm) |
| Compar- | A-1 | O-1 | Phos- | Alum- | B-1 | 5~6 | 99 | C-2 | Or- | Multi- | Side | Silicone | 1 | 3 |
| ative | | | phorus- | ina | | | | | ganic | functional | chain | | | |
| Example | | | doped tin | | | | | | | reactive | | | | |
| 1 | | | oxide | | | | | | | group | | | | |
| Compar- | A-1 | O-2 | Phos- | Alum- | B-1 | 5~6 | 100 | — | — | — | — | — | — | 3 |
| ative | | | phorus- | ina | | | | | | | | | | |
| Example | | | doped tin | | | | | | | | | | | |
| 2 | | | oxide | | | | | | | | | | | |
| Compar- | A-1 | O-3 | Phos- | Alum- | B-2 | 2 | 99 | C-1 | Or- | Multi- | Side | F and | 1 | 3 |
| ative | | | phorus- | ina | | | | | ganic | functional | chain | Silicone | | |
| Example | | | doped tin | | | | | | | reactive | | | | |
| 3 | | | oxide | | | | | | | group | | | | |
| Compar- | A-1 | O-10 | Phos- | Alum- | B-1 | 5~6 | 80 | C-2 | Or- | Multi- | Side | Silicone | 20 | 3 |
| ative | | | phorus- | ina | | | | | ganic | functional | chain | | | |
| Example | | | doped tin | | | | | | | reactive | | | | |
| 4 | | | oxide | | | | | | | group | | | | |
| Compar- | A-1 | O-11 | Phos- | Alum- | B-1 | 5~6 | 99 | C-4 | Sili- | Bifunc- | Side | Silicone | 1 | 3 |
| ative | | | phorus- | ina | | | | | cone | tional | chain | | | |
| Example | | | doped tin | | | | | | | reactive | | | | |
| 5 | | | oxide | | | | | | | group | | | | |
| Compar- | A-1 | O-12 | Phos- | Alum- | B-1 | 5~6 | 90 | C-4 | Sili- | Bifunc- | Side | Silicone | 10 | 3 |
| ative | | | phorus- | ina | | | | | cone | tional | chain | | | |
| Example | | | doped tin | | | | | | | reactive | | | | |
| 6 | | | oxide | | | | | | | group | | | | |
| Example | A-1 | O-4 | Phos- | Alum- | B-3 | 3~4 | 99 | C-1 | Or- | Multi- | Side | F and | 1 | 3 |
| 1 | | | phorus- | ina | | | | | ganic | functional | chain | Silicone | | |
| | | | doped tin | | | | | | | reactive | | | | |
| | | | oxide | | | | | | | group | | | | |
| Example | A-1 | O-5 | Phos- | Alum- | B-1 | 5~6 | 99 | C-1 | Or- | Multi- | Side | F and | 1 | 3 |
| 2 | | | phorus- | ina | | | | | ganic | functional | chain | Silicone | | |
| | | | doped tin | | | | | | | reactive | | | | |
| | | | oxide | | | | | | | group | | | | |
| Example | A-1 | O-6 | Phos- | Alum- | B-1 | 5~6 | 99 | C-3 | Or- | Multi- | Side | Silane | 1 | 3 |
| 3 | | | phorus- | ina | | | | | ganic | functional | chain | | | |
| | | | doped tin | | | | | | | reactive | (Silane | | | |
| | | | oxide | | | | | | | group | coupling) | | | |

TABLE 3

| | | Protective layer | | | | | | | | | | | | |
|---|---|---|---|---|---|---|---|---|---|---|---|---|---|---|
| | Photo- | | | | UV curable | | | Photoreactive group-containing substance | | | | | | |
| | sensitive | | | | multifunctional | | | | Main | | | Water | | Film |
| | layer | Con- | Microparticles | | monomer | | | Main | chain | photo- | Water | repellant | | thick- |
| | Configu- | figu- | n-type | metal | Main | Funcional | | skel- | skel- | reactive | repellent | group | | ness |
| | ration | ration | conductive | oxide | skeleton | group(X) | Ratio | eton | eton | group | group | skeleton | Ratio | (μm) |
| Example | A-1 | O-7 | Phos- | Alum- | B-1 | 5~6 | 90 | C-3 | Or- | Multi- | Side | Silane | 10 | 3 |
| 4 | | | phorus- | ina | | | | | ganic | functional | chain | | | |
| | | | doped tin | | | | | | | reactive | (Silane | | | |
| | | | oxide | | | | | | | group | coupling) | | | |
| Example | A-1 | O-8 | Phos- | Alum- | B-1 | 5~6 | 80 | C-3 | Or- | Multi- | Side | Siane | 20 | 3 |
| 5 | | | phorus- | ina | | | | | ganic | functional | chain | | | |
| | | | doped tin | | | | | | | reactive | (Silane | | | |
| | | | oxide | | | | | | | group | coupling) | | | |
| Example | A-1 | O-9 | Phos- | Alum- | B-1 | 5~6 | 90 | C~2 | Or- | Multi- | Side | Silicone | 10 | 3 |
| 6 | | | phorus- | ina | | | | | ganic | functional | chain | | | |
| | | | doped tin | | | | | | | reactive | | | | |
| | | | oxide | | | | | | | group | | | | |
| Example | A-1 | O-6 | Phos- | Alum- | B-1 | 5~6 | 99 | C-3 | Or- | Multi- | Side | Silane | 1 | 2 |
| 7 | | | phorus- | ina | | | | | ganic | functional | chain | | | |
| | | | doped tin | | | | | | | reactive | | | | |
| | | | oxide | | | | | | | group | | | | |
| Example | A-2 | O-5 | Phos- | Alum- | B-1 | 5~6 | 99 | C-1 | Sili- | Multi- | Side | F and | 1 | 3 |
| | | | phorus- | ina | | | | | cone | functional | chain | Silicone | | |
| 8 | | | doped tin | | | | | | | reactive | | | | |
| | | | oxide | | | | | | | group | | | | |
| Example | A-3 | O-5 | Phos- | Alum- | B-1 | 5~6 | 99 | C-1 | Sili- | Multi- | Side | F and | 1 | 3 |
| 9 | | | phorus- | ina | | | | | cone | functional | chain | Silicone | | |
| | | | doped tin | | | | | | | reactive | | | | |
| | | | oxide | | | | | | | group | | | | |
| Example | A-4 | O-5 | Phos- | Alum- | B-1 | 5~6 | 99 | C-1 | Or- | Multi- | Side | F and | 1 | 3 |
| 10 | | | phorus- | ina | | | | | ganic | functional | chain | Silicone | | |
| | | | doped tin | | | | | | | reactive | | | | |
| | | | oxide | | | | | | | group | | | | |
| Example | A-5 | O-5 | Phos- | Alum- | B-1 | 5~6 | 99 | C~1 | Or- | Multi- | Side | F and | 1 | 3 |
| 11 | | | phorus- | ina | | | | | ganic | functional | chain | Silicone | | |
| | | | doped tin | | | | | | | reactive | | | | |
| | | | oxide | | | | | | | group | | | | |
| Example | A-6 | O-5 | Phos- | Alum- | B-1 | 5~6 | 99 | G-1 | Or- | Multi- | Side | F and | 1 | 3 |
| 12 | | | phorus- | ina | | | | | ganic | functional | chain | Silicone | | |
| | | | doped tin | | | | | | | reactive | | | | |
| | | | oxide | | | | | | | group | | | | |

TABLE 4

| | | Protective layer | | | | | | | | | | | | |
|---|---|---|---|---|---|---|---|---|---|---|---|---|---|---|
| | Photo- | | | | UV curable | | | Photoreactive group-containing substance | | | | | | |
| | sensitive | | | | multifunctional | | | | Main | | | Water | | Film |
| | layer | Con- | Microparticles | | monomer | | | Main | chain | photo- | Water | repellant | | thick- |
| | Configu- | figu- | n-type | metal | Main | Funcional | | skel- | skel- | reactive | repellent | group | | ness |
| | ration | ration | conductive | oxide | skeleton | group(X) | Ratio | eton | eton | group | group | skeleton | Ratio | (μm) |
| Example | A-7 | O-5 | Phos- | Alum- | B-1 | 5~6 | 98 | C-1 | Or- | Multi- | Side | F and | 1 | 3 |
| 13 | | | phorus- | ina | | | | | ganic | functional | chain | Silicone | | |
| | | | doped tin | | | | | | | reactive | | | | |
| | | | oxide | | | | | | | group | | | | |
| Example | A-8 | O-5 | Phos- | Alum- | B-1 | 5~6 | 98 | C-1 | Or- | Multi- | Side | F and | 1 | 3 |
| 14 | | | phorus- | ina | | | | | ganic | functional | chain | Silicone | | |
| | | | doped tin | | | | | | | reactive | | | | |
| | | | oxide | | | | | | | group | | | | |
| Example | A-9 | O-5 | Phos- | Alum- | B-1 | 5~6 | 99 | C-1 | Or- | Multi- | Side | F and | 1 | 3 |
| 15 | | | phorus- | ina | | | | | ganic | functional | chain | Silicone | | |
| | | | doped tin | | | | | | | reactive | | | | |
| | | | oxide | | | | | | | group | | | | |
| Example | A-10 | O-5 | Phos- | Alum- | B-1 | 5~6 | 99 | C-1 | Or- | Multi- | Side | F and | 1 | 3 |
| 16 | | | phorus- | ina | | | | | ganic | functional | chain | Silicone | | |
| | | | doped tin | | | | | | | reactive | | | | |
| | | | oxide | | | | | | | group | | | | |
| Example | A-11 | O-5 | Phos- | Alum- | B-1 | 5~6 | 99 | C-1 | Sili- | Multi- | Side | F and | 1 | 3 |
| 17 | | | phorus- | ina | | | | | cone | functional | chain | Silicone | | |
| | | | doped tin | | | | | | | reactive | | | | |
| | | | oxide | | | | | | | group | | | | |
| Example | A-12 | O-5 | Phos- | Alum- | B-1 | 5~6 | 99 | C-1 | Sili- | Multi- | Side | F and | 1 | 3 |
| 18 | | | phorus- | ina | | | | | cone | functional | chain | Silicone | | |
| | | | doped tin | | | | | | | reactive | | | | |
| | | | oxide | | | | | | | group | | | | |
| Example | A-13 | O-5 | Phos- | Alum- | B-1 | 5~6 | 99 | C-1 | Or- | Multi- | Side | F and | 1 | 3 |
| 19 | | | phorus- | ina | | | | | ganic | functional | chain | Silicone | | |
| | | | doped tin | | | | | | | reactive | | | | |
| | | | oxide | | | | | | | group | | | | |
| Example | A-14 | O-5 | Phos- | Alum- | B-1 | 5~6 | 99 | C-1 | Or- | Multi- | Side | F and | 1 | 3 |
| 20 | | | phorus- | ina | | | | | ganic | functional | chain | Silicone | | |
| | | | doped tin | | | | | | | reactive | | | | |
| | | | oxide | | | | | | | group | | | | |
| Example | A-15 | O-5 | Phos- | Alum- | B-1 | 5~6 | 99 | C-1 | Or- | Multi- | Side | F and | 1 | 3 |
| 21 | | | phorus- | ina | | | | | ganic | functional | chain | Silicone | | |
| | | | doped tin | | | | | | | reactive | | | | |
| | | | oxide | | | | | | | group | | | | |

TABLE 5

| | | Protective layer | | | | | | | | | | | | |
|---|---|---|---|---|---|---|---|---|---|---|---|---|---|---|
| | Photo- | | | | UV curable | | | Photoreactive group-containing substance | | | | | | |
| | sensitive | | | | multifunctional | | | | Main | | | Water | | Film |
| | layer | Con- | Microparticles | | monomer | | | Main | chain | photo- | Water | repellant | | thick- |
| | Configu- | figu- | n-type | metal | Main | Funcional | | skel- | skel- | reactive | repellent | group | | ness |
| | ration | ration | conductive | oxide | skeleton | group(X) | Ratio | eton | eton | group | group | skeleton | Ratio | (μm) |
| Example | A-16 | O-5 | Phos- | Alum- | B-1 | 5~6 | 99 | C-1 | Or- | Multi- | Side | F and | 1 | 3 |
| 22 | | | phorus- | ina | | | | | ganic | functional | chain | Silicone | | |
| | | | doped tin | | | | | | | reactive | | | | |
| | | | oxide | | | | | | | group | | | | |
| Example | A-17 | O-5 | Phos- | Alum- | B-1 | 5~6 | 99 | C-1 | Or- | Multi- | Side | F and | 1 | 3 |
| 23 | | | phorus- | ina | | | | | ganic | functional | chain | Silicone | | |
| | | | doped tin | | | | | | | reactive | | | | |
| | | | oxide | | | | | | | group | | | | |
| Example | A-18 | O-5 | Phos- | Alum- | B-1 | 5~6 | 99 | C-1 | Or- | Multi- | Side | F and | 1 | 3 |
| 24 | | | phorus- | ina | | | | | ganic | functional | chein | Silicone | | |
| | | | doped tin | | | | | | | reactive | | | | |
| | | | oxide | | | | | | | group | | | | |
| Example | A-19 | O-5 | Phos- | Alum- | B-1 | 5~6 | 99 | C-1 | Or- | Multi- | Side | F and | 1 | 3 |
| 25 | | | phorus- | ina | | | | | ganic | functional | chain | Silicone | | |
| | | | doped tin | | | | | | | reactive | | | | |
| | | | oxide | | | | | | | group | | | | |
| Example | A-20 | O-5 | Phos- | Alum- | B-1 | 5~6 | 99 | C-1 | Sili- | Multi- | Side | F and | 1 | 3 |
| 26 | | | phorus- | ina | | | | | cone | functional | chain | Silicone | | |
| | | | doped tin | | | | | | | reactive | | | | |
| | | | oxide | | | | | | | group | | | | |
| Example | A-21 | O-5 | Phos- | Alum- | B-1 | 5~6 | 99 | C-1 | Sili- | Multi- | Side | F and | 1 | 3 |
| 27 | | | phorus- | ina | | | | | cone | functional | chain | Silicone | | |
| | | | doped tin | | | | | | | reactive | | | | |
| | | | oxide | | | | | | | group | | | | |
| Example | A-22 | O-5 | Phos- | Alum- | B-1 | 5~6 | 99 | C-1 | Or- | Multi- | Side | F and | 1 | 3 |
| 28 | | | phorus- | ina | | | | | ganic | functional | chain | Silicone | | |
| | | | doped tin | | | | | | | reactive | | | | |
| | | | oxide | | | | | | | group | | | | |
| Example | A-23 | O-5 | Phos- | Alum- | B-1 | 5~6 | 99 | C-1 | Or- | Multi- | Side | F and | 1 | 3 |
| 29 | | | phorus- | ina | | | | | ganic | functional | chain | Silicone | | |
| | | | doped tin | | | | | | | reactive | | | | |
| | | | oxide | | | | | | | group | | | | |
| Example | B-1 | O-5 | Phos- | Alum- | B-1 | 5~6 | 99 | C-1 | Or- | Multi- | Side | F and | 1 | 3 |
| 30 | | | phorus- | ina | | | | | ganic | functional | chain | Silicone | | |
| | | | doped tin | | | | | | | reactive | | | | |
| | | | oxide | | | | | | | group | | | | |

In each Table, configurations of the photosensitive layer indicated by “A-1” to “A-23” and “B-1” are those described in Tables 6 and 7 below. Furthermore, configurations of the protective layer indicated by “O-1” to “O-12” are those described in Tables 2 and 5. Furthermore, “B-1” to “B-3,” which indicate main backbones of the UV curable multifunctional monomer, are the compounds shown in the above formula (B-1) to formula (B-3). “C-1” to “C-4,” which indicate main backbones of the photoreactive group-containing substance, are compounds shown in the above formula (C-1) to formula (C-4).

### <Preparation of Single-Layered Electrophotographic Photosensitive Members>

The electrophotographic photosensitive members according to Examples 1 to 29 and Comparative Examples 1 to 6 are the single-layered electrophotographic photosensitive members and were prepared as follows:

First, the undercoat layer was formed on the conductive base as follows: 2 parts by weight of titanium oxide “SMT-A” (manufactured by Teika Co., Ltd., number-average primary particle size 10 nm), which was surface-treated with methyl hydrogen polysiloxane while wet dispersion after surface treatment with alumina and silica, and 1 part by weight of 6,12,66,610 quaternary copolymer polyamide resin “Amilan (registered trademark) CM8000” (manufactured by Toray Industries, Inc.) were dispersed in a solvent using a ball mill. The dispersion time was 5 hours. The solvent included 10 parts by weight of methanol, 1 part by weight of butanol, and 1 part by weight of toluene. The prepared dispersion was filtered using a mesh filter with an opening size of 5 μm to produce a coating solution. The coating solution was coated onto the conductive base using a dip coating method. The coated film was dried at 130° C. for 30 minutes to form the undercoat layer. A thickness of the undercoat layer was 2 μm.

Next, the photosensitive layer was formed on the undercoat layer as follows: Table 6 below shows the configuration of each photosensitive layer. 2.85 parts by weight of a charge generation material (CGM), 80 parts by weight of a hole transport material (HTM), 68 parts by weight of an electron transport material (ETM), 0.02 parts by weight of dimethyl silicone oil (“KF96-50CS” manufactured by Shin-Etsu Chemical Co., Ltd.) as the leveling agent, and 70 parts by weight of polycarbonate resin as the binder resin were dispersed in a solvent using a rod-shaped ultrasonic oscillator. The dispersion time was 2 minutes. The solvent was 500 parts by weight of tetrahydrofuran. The polycarbonate resin was a polycarbonate resin (molecular weight 50,000) having bisphenol represented by the above formula (R-1) as the monomer and DMP (dimethyl phthalate) as the terminal stopping agent. Each type of the charge generation material (CGM), the hole transport material (HTM), and the electron transport material (ETM) is shown in Table 6. Note that “HT-2/HT-3” indicates 40 parts by weight of the compound represented by the formula (HT-2) and 40 parts by weight of the compound represented by the formula (HT-3).

TABLE 6

| Configuration | Charge | Hole | Number of | Electron | |
|---|---|---|---|---|---|
| of | generation | transport | unsubstituted | transport | HTM + ETM |
| photosensitive | material | material | olefin | material | content |
| layer | (CGM) | (HTM) | n | (ETM) | [wt %] |
| A-1 | CG-1 | HT-2 | 1 | ET-1/ET-6 | 40 |
| A-2 | CG-1 | HT-3 | 0 | | 40 |
| A-3 | CG-1 | HT-4 | 0 | | 40 |
| A-4 | CG-1 | HT-2 | 1 | ET-1 | 40 |
| A-5 | CG-1 | HT-2 | 1 | ET-2 | 40 |
| A-6 | CG-1 | HT-2 | 1 | ET-3 | 40 |
| A-7 | CG-1 | HT-2 | 1 | ET-4 | 40 |
| A-8 | CG-1 | HT-2 | 1 | ET-5 | 40 |
| A-9 | CG-1 | HT-2 | 1 | ET-6 | 40 |
| A-10 | CG-1 | HT-2 | 1 | ET-7 | 40 |
| A-11 | CG-1 | HT-2/HT-3 | 0.5 | ET-1/ET-6 | 40 |
| A-12 | CG-2 | HT-2 | 1 | ET-1/ET-6 | 40 |
| A-13 | CG-2 | HT-3 | 0 | | 40 |
| A-14 | CG-2 | HT-4 | 0 | | 40 |
| A-15 | CG-2 | HT-2 | 1 | ET-1 | 40 |
| A-16 | CG-2 | HT-2 | 1 | ET-2 | 40 |
| A-17 | CG-2 | HT-2 | 1 | ET-3 | 40 |
| A-18 | CG-2 | HT-2 | 1 | ET-4 | 40 |
| A-19 | CG-2 | HT-2 | 1 | ET-5 | 40 |
| A-20 | CG-2 | HT-2 | 1 | ET-6 | 40 |
| A-21 | CG-2 | HT-2 | 1 | ET-7 | 40 |
| A-22 | CG-2 | HT-2/HT-3 | 0.5 | ET-1/ET-6 | 40 |
| A-23 | CG-1 | HT-2/HT-3 | 0.5 | ET-1/ET-6 | 40 |

The prepared dispersion was filtered using the mesh filter with the opening size of 5 μm to produce a coating solution. The coating solution was coated onto the undercoat layer using the dip coating method. The coated film was dried at 110° C. for 60 minutes to form the photosensitive layer. A thickness of the photosensitive layer was 25 μm.

Next, the protective layer was formed on the photosensitive layer as follows: 3.5 parts by weight of the metal oxide microparticles, 9.3 parts by weight of the n-type conductive microparticles, the UV curable multifunctional monomer (variable amount), the photoreactive group-containing substance (variable amount), and 10 parts by weight of the photopolymerization initiator were dispersed in a solvent using the bead mill. The dispersion time was 10 hours. The solvent was 110 parts by weight of methanol. Each type of the metal oxide microparticles, the n-type conductive microparticles, the UV curable multifunctional monomer, and the photoreactive group-containing substance is as shown in Tables 2 to 5 above. A total content of the UV curable multifunctional monomer and the photoreactive group-containing substance was 91 parts by weight, with a ratio of each content shown in Tables 2 to 5 above. The photopolymerization initiator was acylphosphine oxide (Formula (P-1) above).

The prepared dispersion was filtered using the mesh filter with the opening size of 5 μm to produce a coating solution. The coating solution was coated onto the photosensitive layer using the dip coating method. Light from an LED light source with an emission wavelength of 365 nm was irradiated onto the coating solution to form the protective layer. A thickness of the protective layer was 3 μm. Each electrophotographic photosensitive member according to Example 1 to 29 and Comparative Example 1 to 6 was prepared as described above.

### <Production of Multilayered Electrophotographic Photosensitive Member>

The electrophotographic photosensitive member in Example 30 is the layered electrophotographic photosensitive member and was prepared as follows: First, the undercoat layer was formed on the conductive base. The undercoat layer was formed using the same process as the undercoat layer formation process in the above single-layered electrophotographic photosensitive member.

Next, the photosensitive layer was formed on the undercoat layer as follows: Table 7 below shows the configuration of the photosensitive layer. First, the charge generation layer was formed on the undercoat layer as follows: As a formation methos of the charge generation layer, 1.5 parts by weight of the charge generation material (CGM) and 1 part by weight of polyvinyl acetate resin (“Eslec (registered trademark) BX-5” manufactured by Sekisui Chemical Co., Ltd.) as the binder resin were dispersed in a solvent using the bead mill. The dispersion time was 12 hours. The solvent was a mixture of 40 parts by weight of propylene glycol monomethyl ether and 40 parts by weight of tetrahydrofuran. A type of the charge generation material (CGM) is shown in Table 7. The prepared dispersion was filtered using a mesh filter with an opening size of 3 μm to produce a coating solution. The coating solution was coated onto the undercoat layer using the dip coating method. The coated film was dried at 50° C. for 5 minutes to form the charge generation layer. A thickness of the charge generation layer was 0.2 μm.

TABLE 7

| | Charge | | | |
|---|---|---|---|---|
| | generation | | | |
| | layer | Electron transport layer | | |
| Configuration | Charge | Hole | Number of | |
| of | generation | transport | unsubstituted | HTM |
| photosensitive | material | material | olefin | content |
| layer | (CGM) | (HTM) | n | [wt %] |
| B-1 | CG-1 | HT-2/HT-3 | 0.5 | 47 |

Subsequently, the charge transport layer was formed on the charge generation layer as follows: 60 parts by weight of the compound shown in the above formula (HT-2) as the hole transport material (HTM), 30 parts by weight of the compound shown in the above formula (HT-3), 100 parts by weight of polycarbonate resin as the binder resin, various pigments, and 0.05 parts by weight of dimethyl silicone oil (“KF96-50CS” manufactured by Shin-Etsu Chemical Co., Ltd.) as the leveling agent were dispersed in a solvent using the roll mill. The solvent was a mixture of 340 parts by weight of tetrahydrofuran and 60 parts by weight of toluene. The prepared dispersion was filtered using the mesh filter with the opening size of 3 μm to produce the coating solution. The coating solution was coated onto the charge generation layer using the dip coating method. The coated film was dried at 120° C. for 40 minutes to form the hole transport layer. A thickness of the charge generation layer was 25 μm.

Next, the protective layer was formed on the hole transport layer. The protective layer was formed using the same process as the protective layer formation process in the above single-layered electrophotographic photosensitive member.

### <Measurement and Evaluation>

Various measurements and evaluations were performed on the electrophotographic photosensitive members according to Examples and Comparative Examples prepared as described above. Measurement results and evaluation results are shown in Tables 8 and 9 below.

TABLE 8

| | | | Film | | Scratches on |
|---|---|---|---|---|---|
| | Martens | Volume | formation | Image | photosensitive |
| | hardness | resistivity | properties | bleeding | member surface |
| Comparative | 471.9 | 8.9 | A | B | Absent |
| Example 1 | | | | | |
| Comparative | 485.7 | 9.94 | B | B | Absent |
| Example 2 | | | | | |
| Comparative | 160.1 | 8.9 | B | — | Present |
| Example 3 | | | | | |
| Comparative | 390.9 | 10.68 | A | A | Present |
| Example 4 | | | | | |
| Comparative | 448.8 | 9.13 | A | B | Absent |
| Example 5 | | | | | |
| Comparative | 375.3 | 9.3 | A | B | Present |
| Example 6 | | | | | |
| Example 1 | 403.0 | 10.02 | A | A | Absent |
| Example 2 | 443.2 | 10.14 | A | A | Absent |
| Example 3 | 471.4 | 10.01 | A | A | Absent |
| Example 4 | 458.5 | 11.9 | A | A | Absent |
| Example 5 | 444.0 | 11.78 | A | A | Absent |
| Example 6 | 434.0 | 9.75 | A | A | Absent |
| Example 7 | 471.4 | 10.01 | A | A | Absent |
| Example 8 | 443.2 | 10.01 | A | A | Absent |
| Example 9 | 443.2 | 10.01 | A | A | Absent |
| Example 10 | 443.2 | 10.01 | A | A | Absent |
| Example 11 | 443.2 | 10.01 | A | A | Absent |
| Example 12 | 443.2 | 10.01 | A | A | Absent |

TABLE 9

| | | | Film | | Scratches on |
|---|---|---|---|---|---|
| | Martens | Volume | formation | Image | photosensitive |
| | hardness | resistivity | properties | bleeding | member surface |
| Example 13 | 443.2 | 10.01 | A | A | Absent |
| Example 14 | 443.2 | 10.01 | A | A | Absent |
| Example 15 | 443.2 | 10.01 | A | A | Absent |
| Example 16 | 443.2 | 10.01 | A | A | Absent |
| Example 17 | 443.2 | 10.01 | A | A | Absent |
| Example 18 | 443.2 | 10.01 | A | A | Absent |
| Example 19 | 443.2 | 10.01 | A | A | Absent |
| Example 20 | 443.2 | 10.01 | A | A | Absent |
| Example 21 | 443.2 | 10.01 | A | A | Absent |
| Example 22 | 443.2 | 10.01 | A | A | Absent |
| Example 23 | 443.2 | 10.01 | A | A | Absent |
| Example 24 | 443.2 | 10.01 | A | A | Absent |
| Example 25 | 443.2 | 10.01 | A | A | Absent |
| Example 26 | 443.2 | 10.01 | A | A | Absent |
| Example 27 | 443.2 | 10.01 | A | A | Absent |
| Example 28 | 443.2 | 10.01 | A | A | Absent |
| Example 29 | 443.2 | 10.01 | A | A | Absent |
| Example 30 | 443.2 | 10.01 | A | A | Absent |

### <Martens Hardness Measurement>

The Martens hardness of the surface of the photosensitive member, specifically the surface of the protective layer, was measured for each of the electrophotographic photosensitive layers according to Examples and Comparative Examples. The Martens hardness was measured using a method compliant with ISO 14577. Specifically, a hardness tester (“FISCHERSCOPE (registered trademark) HM2000XYp” (manufactured by Fischer Instruments)) was used. An indenter was a diamond square-pyramid indenter (opposite angle 135 degrees). A load was applied gradually at 0.4 μm or 0.1 μm/20 seconds, held for 5 seconds, and removed after 20 seconds following the hold. Using such indentation conditions, the measurement was performed. The environment was set at 23° C. and 50% humidity. The measurement results are shown as “Martens hardness” in Tables 8 and 9.

### <Volume Resistivity Measurement>

The volume resistivity was measured for the electrophotographic photosensitive members according to Examples and Comparative Examples. The volume resistivity was measured by pressing an electrode probe of a resistivity meter onto the surface of the protective layer and applying a voltage of 100 V for 10 seconds. The resistivity meter used was the Hiresta-UX MCP-HT800 (manufactured by Mitsubishi Chemical Analytical). The measurement results are shown as “volume resistivity” in Tables 8 and 9.

### <Film Formation Properties Evaluation>

The film formation properties of the protective layer were evaluated for each of the electrophotographic photosensitive member according to Examples and Comparative Examples. After coating the coating solution forming the protective layer onto the photosensitive layer during the manufacturing process, the surface was observed. Defects (cissings) on the surface were visually confirmed, and the surface without defects was rated as “Good (O)”, while the surface with defects was rated as “Bad (x)”. The evaluation results are shown as “film formation properties” in Tables 8 and 9.

### <Image Bleeding Evaluation>

Each electrophotographic photosensitive member according to Examples and Comparative Examples was mounted on an evaluation machine and printing was performed. The evaluation machine is a modified version of a printer “TaskAlfa 356ci” (manufactured by Kyocera Document Solutions Inc.) and employs an intermediate transfer method. The evaluation machine is equipped with a charging roller configured of a charging rubber (epichlorohydrin resin with dispersed conductive carbon). When setting the single-layered electrophotographic photosensitive member (Examples 1 to 29 and Comparative Examples 1 to 6) to the evaluation machine, a charging polarity of the photosensitive member was set to positive, and the applied voltage was direct current (DC). When setting the multilayer electrophotographic photosensitive member (Example 30) to the evaluation machine, the charging polarity of the electrophotographic photosensitive member was set to negative, and the applied voltage was direct current (DC).

Using the above evaluation machine, 600 prints were executed at a print image density of 1.6%. The printing paper used was “Askul Multipaper Super Economy+”, and the environment was set to a temperature of 32° C. and humidity of 80%. An printed image on a final page was observed under a microscope. If dots and characters were properly reproduced, it was evaluated as “Good (◯)”; if the dots or the characters were missing and could not be confirmed, it was evaluated as “Bad (x)”. The evaluation results are shown as “image bleeding” in Table 8 and Table 9.

### <Abrasion Resistance Evaluation>

After printing the aforementioned 600 sheets, the surface of the electrophotographic photosensitive member was visually inspected to check for scratches. If no scratches were present, it was rated as “Absent”; if scratches were present, it was rated as “Present”. The evaluation results are shown as “Abrasion resistance” in Tables 8 and 9.

### <Regarding Evaluation Results>

As shown in Tables 8 and 9, the electrophotographic photosensitive members according to Examples all received the evaluations Good (O) for the film formation and the image bleeding, and scratches are absent on the surface of the electrophotographic photosensitive members. In contrast, the electrophotographic photosensitive members according to Comparative Examples received the evaluations Bad (x) for at least one of the film-forming properties or the image bleeding, or the scratches are present on the surface of the electrophotographic photosensitive members. Therefore, it can be concluded that the electrophotographic photosensitive members according to the above embodiments exhibit excellent abrasion resistance and are capable of suppressing the image bleeding.

It should be understood by those skilled in the art that various modifications, combinations, sub-combinations and alterations may occur depending on design requirements and other factors insofar as they are within the scope of the appended claims or the equivalents thereof.

What is claimed is:

1. An electrophotographic photosensitive member according, comprising:
a conductive base;
a photosensitive layer provided on the conductive base; and
a protective layer provided on the photosensitive layer; wherein the protective layer has a base material formed from a graft polymer configured of a UV (ultraviolet) curable multifunctional monomer, a photopolymerization initiator, and a photoreactive group-containing substance, n-type conductive microparticles dispersed in the base material, and metal oxide microparticles dispersed in the base material, and has a Martens hardness of 400 N/mm² or more and a volume resistivity of 1.0×10¹⁰ Ω·cm or more.

2. The electrophotographic photosensitive member according to claim 1, wherein the UV curable multifunctional monomer has three or more (meth)acrylic groups.

3. The electrophotographic photosensitive member according to claim 1, wherein the photoreactive group-containing substance is a graft polymer having an organic main chain and a side chain having multiple reactive groups and a fluorine-modified silicone skeleton or silane skeleton as a release skeleton.

4. The electrophotographic photosensitive member according to claim 1, wherein the photopolymerization initiator is an acylphosphine oxide.

5. The electrophotographic photosensitive member according to claim 1, wherein the protective layer has a thickness of 2 μm or more and 3 μm or less.

6. The electrophotographic photosensitive member according to claim 1, wherein the photosensitive layer contains an electron transport material including any compound represented by the following general formulae (1) to (6) 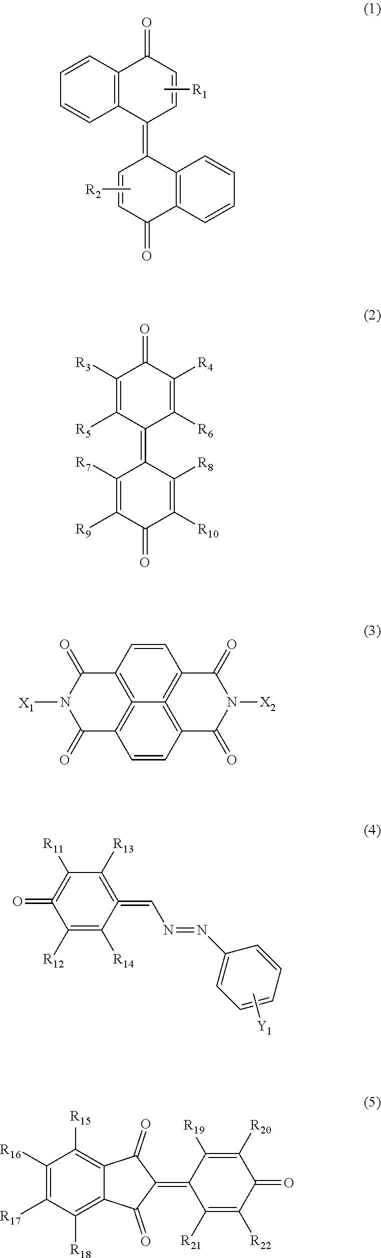 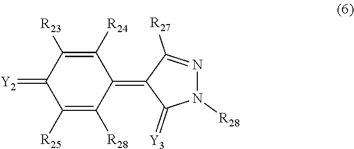
in general formulae (1) to (6), R₁ to R₂₈ each independently represents a hydrogen atom, a halogen atom, a cyano group, or an alkyl group having 1 to 6 carbon atoms; X₁ and X₂ each independently represents an alkenyl group having 2 to 6 carbon atoms, an alkoxy group having 1 to 6 carbon atoms, or an aryl group having 6 to 14 carbon atoms which may have at least one alkyl group having 1 to 6 carbon atoms; Y₁ to Y₃ each independently represents a halogen group or an oxygen atom.

7. The electrophotographic photosensitive member according to claim 1, wherein the photosensitive layer contains a hole transport material including any compound represented by the following general formulae (7) to (10) 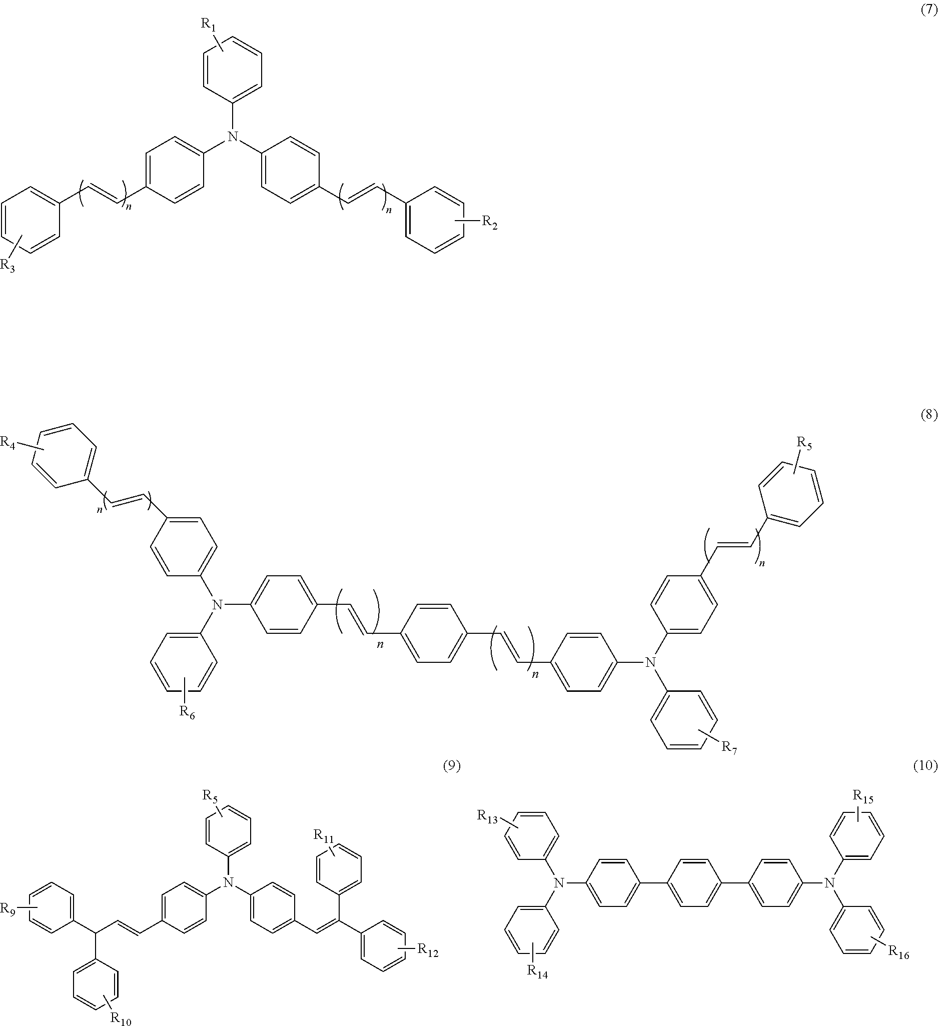
in general formulae (7) to (10), R₁ to R₁₆ each independently represents a hydrogen atom, an alkyl group having 1 to 8 carbon atoms, or a phenyl group; n represents a natural number of 1 or less.

8. The electrophotographic photosensitive member according to claim 1, wherein the photosensitive layer contains a charge generation material which is a titanyl phthalocyanine or an inorganic phthalocyanine.

9. The electrophotographic photosensitive member according to claim 1, wherein the protective layer is formed by coating a coating solution including the UV curable multifunctional monomer, the photoreactive group-containing substance, the photopolymerization initiator, the n-type conductive microparticles, and the metal oxide microparticles onto the photosensitive layer, and then irradiating the coating solution with light.

10. The electrophotographic photosensitive member according to claim 9, wherein the light is light having a wavelength of 365 nm.

11. A process cartridge, comprising:
a conductive base;
a photosensitive layer provided on the conductive base; and
a protective layer provided on the photosensitive layer; wherein the protective layer has a base material formed from a graft polymer configured of a UV (ultraviolet) curable multifunctional monomer, a photopolymerization initiator, and a photoreactive group-containing substance, n-type conductive microparticles dispersed in the base material, and metal oxide microparticles dispersed in the base material, and has a Martens hardness of 400 N/mm² or more and a volume resistivity of 1.0×10¹⁰ Ω·cm or more.

12. An image forming apparatus, comprising:
a conductive base;
a photosensitive layer provided on the conductive base; and
a protective layer provided on the photosensitive layer; wherein the protective layer has a base material formed from a graft polymer configured of a UV (ultraviolet) curable multifunctional monomer, a photopolymerization initiator, and a photoreactive group-containing substance, n-type conductive microparticles dispersed in the base material, and metal oxide microparticles dispersed in the base material, and has a Martens hardness of 400 N/mm² or more and a volume resistivity of 1.0×10¹⁰ Ω·cm or more.

13. The image forming apparatus according to claim 12, wherein the charging device includes a charging roller.

14. The image forming apparatus according to claim 12, wherein the developing device is a two-component developing system, a one-component developing system, or a rub roller system image forming apparatus.
